(19) United States
(12) Patent Application Publication
(10) Pub. No.: US 2014/0119267 A1
(43) Pub. Date: May 1, 2014

(54) APPLICATION-LAYER HANDOFF OF AN ACCESS TERMINAL FROM A FIRST SYSTEM OF AN ACCESS NETWORK TO A SECOND SYSTEM OF THE ACCESS NETWORK DURING A COMMUNICATION SESSION WITHIN A WIRELESS COMMUNICATIONS SYSTEM

(71) Applicant: QUALCOMM Incorporated, San Diego, CA (US)

(72) Inventors: Arvind SANTHANAM, San Diego, CA (US); Bongyong SONG, San Diego, CA (US); Kirankumar ANCHAN, San Diego, CA (US)

(73) Assignee: QUALCOMM Incorporated, San Diego, CA (US)

(21) Appl. No.: 14/146,644

(22) Filed: Jan. 2, 2014

Related U.S. Application Data
(63) Continuation-in-part of application No. 13/750,029, filed on Jan. 25, 2013.
Application No. 13/750,029 is a continuation of application No. 12/693,099, filed on Jan. 25, 2010, now abandoned.
(60) Provisional application No. 61/748,847, filed on Jan. 4, 2013.

(51) Int. Cl. H04W 4/06; H04W 48/18

(52) U.S. Cl. CPC H04W 4/06; H04W 48/18
USPC 370/312

(57) ABSTRACT

The disclosure uses a low-cost local wireless network to expand coverage of a multicast service. A user device determines whether a signal strength for a detected wireless multicast service is greater than a threshold, determines whether a low cost local wireless network is available, and communicates with an application server over the low cost local wireless network based on the signal strength being not greater than the threshold and the low cost local wireless network being available. A server receives a request from a user device to send multicast communications to the user device over the low cost local wireless network serving the user device, wherein the user device sends the request based on a signal strength of a detected wireless multicast network being less than a threshold and the low cost local wireless network being available, and communicates with the use device over the low cost local wireless network.

### CROSS REFERENCE TO RELATED APPLICATIONS

The present Application for Patent is a Continuation-in-part of patent application Ser. No. 13/750,029, filed Jan. 25, 2013, entitled “APPLICATION-LAYER HANDOFF OF AN ACCESS TERMINAL FROM A FIRST SYSTEM OF AN ACCESS NETWORK TO A SECOND SYSTEM OF THE ACCESS NETWORK DURING A COMMUNICATION SESSION WITHIN A WIRELESS COMMUNICATIONS SYSTEM,” and assigned to the assignee hereof and hereby expressly incorporated by reference herein, which is a Continuation of patent application Ser. No. 12/693,099, filed Jan. 25, 2010, entitled “APPLICATION-LAYER HANDOFF OF AN ACCESS TERMINAL FROM A FIRST SYSTEM OF AN ACCESS NETWORK TO A SECOND SYSTEM OF THE ACCESS NETWORK DURING A COMMUNICATION SESSION WITHIN A WIRELESS COMMUNICATIONS SYSTEM,” and assigned to the assignee hereof and hereby expressly incorporated by reference herein. The present Application for Patent also claims the benefit of Provisional Application No. 61/748,847, entitled “EXPANDING THE FOOTPRINT OF A WIRELESS MULTICAST SERVICES USED FOR DELIVERING GROUP COMMUNICATIONS BY USING LOW COST LOCAL WIRELESS NETWORKS,” filed Jan. 4, 2013, and assigned to the assignee hereof and hereby expressly incorporated by reference herein.

### BACKGROUND

1. Field of the Disclosure

Aspects of the disclosure are related to expanding the footprint of a wireless multicast services used for delivering group communications by using low cost local wireless networks.

2. Description of the Related Art

Wireless communication systems have developed through various generations, including a first-generation analog wireless phone service (1G), a second-generation (2G) digital wireless phone service (including interim 2.5G and 2.75G networks) and a third-generation (3G) high speed data/Internet-capable wireless service. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Time Division Multiple Access (TDMA), the Global System for Mobile access (GSM) variation of TDMA, and newer hybrid digital communication systems using both TDMA and CDMA technologies.

The method for providing CDMA mobile communications was standardized in the United States by the Telecommunications Industry Association/Electronic Industries Association in TIA/EIA/IS-95-A entitled “Mobile Station-Base Station Compatibility Standard for Dual-Mode Wideband Spread Spectrum Cellular System,” referred to herein as IS-95. Combined AMPS & CDMA systems are described in TIA/EIA Standard IS-98. Other communications systems are described in the IMT-2000/UM, or International Mobile Telecommunications System 2000/Universal Mobile Telecommunications System, standards covering what are referred to as wideband CDMA (WCDMA), CDMA2000 (such as CDMA2000 1xEV-DO standards, for example) or TD-SCDMA.

In wireless communication systems, mobile stations, handsets, or access terminals (AT) receive signals from fixed position base stations (also referred to as cell sites or cells) that support communication links or service within particular geographic regions adjacent to or surrounding the base stations. Base stations provide entry points to an access network (AN)/radio access network (RAN), which is generally a packet data network using standard Internet Engineering Task Force (IETF) based protocols that support methods for differentiating traffic based on Quality of Service (QoS) requirements. Therefore, the base stations generally interact with ATs through an over the air interface and with the AN through Internet Protocol (IP) network data packets.

In wireless telecommunication systems, Push-to-talk (PTT) capabilities are becoming popular with service sectors and consumers. PTT can support a “dispatch” voice service that operates over standard commercial wireless infrastructures, such as CDMA, FDMA, TDMA, GSM, etc. In a dispatch model, communication between endpoints (ATs) occurs within virtual groups, wherein the voice of one “talker” is transmitted to one or more “listeners.” A single instance of this type of communication is commonly referred to as a dispatch call, or simply a PTT call. A PTT call is an instantiation of a group, which defines the characteristics of a call. A group in essence is defined by a member list and associated information, such as group name or group identification.

Conventionally, data packets within a wireless communications network have been configured to be sent to a single destination or access terminal. A transmission of data to a single destination is referred to as “unicast”. As mobile communications have increased, the ability to transmit given data concurrently to multiple access terminals has become more important. Accordingly, protocols have been adopted to support concurrent data transmissions of the same packet or message to multiple destinations or target access terminals. A “broadcast” refers to a transmission of data packets to all destinations or access terminals (e.g., within a given cell, served by a given service provider, etc.), while a “multicast” refers to a transmission of data packets to a given group of destinations or access terminals. In an example, the given group of destinations or “multicast group” may include more than one and less than all of possible destinations or access terminals (e.g., within a given group, served by a given service provider, etc.). However, it is at least possible in certain situations that the multicast group comprises only one access terminal, similar to a unicast, or alternatively that the multicast group comprises all access terminals (e.g., within a cell or sector), similar to a broadcast.

Broadcasts and/or multicasts may be performed within wireless communication systems in a number of ways, such as performing a plurality of sequential unicast operations to accommodate the multicast group, allocating a unique broadcast/multicast channel (BCH) for handling multiple data transmissions at the same time and the like. A conventional system using a broadcast channel for push-to-talk communications is described in United States Patent Application Publication No. 2007/0049314 dated Mar. 1, 2007 and entitled “Push-To-Talk Group Call System Using CDMA 1x-EVDO Cellular Network”, the contents of which are incorporated herein by reference in its entirety. As described in Publication No. 2007/0049314, a broadcast channel can be used for push-to-talk calls using conventional signaling techniques. Although the use of a broadcast channel may improve bandwidth requirements over conventional unicast techniques, the conventional signaling of the broadcast channel can still result in additional overhead and/or delay and may degrade system performance.

The 3^{rd} Generation Partnership Project 2 (“3GPP2”) defines a broadcast-multicast service (BCMCS) specification for supporting multicast communications in CDMA2000 networks. Accordingly, a version of 3GPP2's BCMCS specification, entitled “CDMA2000 High Rate Broadcast-Multicast Packet Data Air Interface Specification”, dated Feb. 14, 2006, Version 1.0 C.S0054-A, is hereby incorporated by reference in its entirety.

### SUMMARY

The disclosure is related to using a low cost local wireless network to expand a coverage area of a wireless multicast service. A method for using a low cost local wireless network to expand a coverage area of a wireless multicast service includes determining, by a wireless user device, whether a signal strength of a detected wireless multicast service is greater than a threshold, determining, by the wireless user device, whether a low cost local wireless network is available, and communicating, by the wireless user device, with an application server over the low cost local wireless network based on the signal strength being not greater than the threshold and the low cost network being available.

A method for using a low cost local wireless network to expand a coverage area of a wireless multicast service includes receiving, by an application server, a request from a wireless user device to send multicast communications to the wireless user device over a low cost local wireless network serving the wireless user device, wherein the wireless user device sends the request based on a signal strength of a detected wireless multicast network being less than a threshold and the low cost local wireless network being available, and communicating, by the application server, with the wireless user device over the low cost local wireless network.

An apparatus for using a low cost local wireless network to expand a coverage area of a wireless multicast service includes logic configured to determine, by a wireless user device, whether a signal strength of a detected wireless multicast service is greater than a threshold, logic configured to determine, by the wireless user device, whether a low cost local wireless network is available, and logic configured to communicate, by the wireless user device, with an application server over the low cost local wireless network based on the signal strength being not greater than the threshold and the low cost network being available.

An apparatus for using a low cost local wireless network to expand a coverage area of a wireless multicast service includes logic configured to receive, by an application server, a request from a wireless user device to send multicast communications to the wireless user device over a low cost local wireless network serving the wireless user device, wherein the wireless user device sends the request based on a signal strength of a detected wireless multicast network being less than a threshold and the low cost local wireless network being available, and logic configured to communicate, by the application server, with the wireless user device over the low cost local wireless network.

An apparatus for using a low cost local wireless network to expand a coverage area of a wireless multicast service includes means for determining, by a wireless user device, whether a signal strength of a detected wireless multicast service is greater than a threshold, means for determining, by the wireless user device, whether a low cost local wireless network is available, and means for communicating, by the wireless user device, with an application server over the low cost local wireless network based on the signal strength being not greater than the threshold and the low cost network being available.

An apparatus for using a low cost local wireless network to expand a coverage area of a wireless multicast service includes means for receiving, by an application server, a request from a wireless user device to send multicast communications to the wireless user device over a low cost local wireless network serving the wireless user device, wherein the wireless user device sends the request based on a signal strength of a detected wireless multicast network being less than a threshold and the low cost local wireless network being available, and means for communicating, by the application server, with the wireless user device over the low cost local wireless network.

A non-transitory computer-readable medium for using a low cost local wireless network to expand a coverage area of a wireless multicast service includes at least one instruction to determine, by a wireless user device, whether a signal strength of a detected wireless multicast service is greater than a threshold, at least one instruction to determine, by the wireless user device, whether a low cost local wireless network is available, and at least one instruction to communicate, by the wireless user device, with an application server over the low cost local wireless network based on the signal strength being not greater than the threshold and the low cost network being available.

A non-transitory computer-readable medium for using a low cost local wireless network to expand a coverage area of a wireless multicast service includes at least one instruction to receive, by an application server, a request from a wireless user device to send multicast communications to the wireless user device over a low cost local wireless network serving the wireless user device, wherein the wireless user device sends the request based on a signal strength of a detected wireless multicast network being less than a threshold and the low cost local wireless network being available, and at least one instruction to communicate, by the application server, with the wireless user device over the low cost local wireless network.

### BRIEF DESCRIPTION OF THE DRAWINGS

A more complete appreciation of embodiments of the disclosure and many of the attendant advantages thereof will be readily obtained as the same becomes better understood by reference to the following detailed description when considered in connection with the accompanying drawings which are presented solely for illustration and not limitation of the disclosure, and in which:

FIG. 1 is a diagram of a wireless network architecture that supports access terminals and access networks in accordance with at least one embodiment of the disclosure.

FIG. 2A illustrates the core network of FIG. 1 according to an embodiment of the present disclosure.

FIG. 2B illustrates an example of the wireless communications system of FIG. 1 in more detail.

FIG. 3 is an illustration of an access terminal in accordance with at least one embodiment of the disclosure.

FIG. 4 illustrates a conventional inter-system handoff of a given access terminal that is participating in a wireless communication session.

FIG. 5 illustrates a system-handoff of a given access terminal that is participating in a wireless communication session in accordance with an embodiment of the disclosure.

FIG. 6A illustrates the system-handoff process of FIG. 5 whereby one application-layer performance parameter corresponds to a location of the given access terminal within the wireless communications system in accordance with an embodiment of the disclosure.

FIG. 6B illustrates the system-handoff process of FIG. 5 whereby one application-layer performance parameter corresponds to a media error rate (MER) for the given access terminal's communication session within the wireless communications system in accordance with an embodiment of the disclosure.

FIG. 6C illustrates the system-handoff process of FIG. 5 whereby one application-layer performance parameter corresponds to an outage duration for the given access terminal's communication session within the wireless communications system in accordance with an embodiment of the disclosure.

FIG. 6D illustrates the system-handoff process of FIG. 5 whereby one application-layer performance parameter corresponds to a current rate at which a subscriber using the given access terminal is being charged for service related to the given access terminal's communication session within the wireless communications system in accordance with an embodiment of the disclosure.

FIG. 6E illustrates the system-handoff process of FIG. 5 whereby one or more application-layer performance parameters are considered during a potential handoff of the given access terminal from a first system to one of a plurality of other potential systems during the given access terminal's communication session within the wireless communications system in accordance with an embodiment of the disclosure.

FIG. 7A is an illustration of a wireless network that can implement MBMS/eMBMS as disclosed herein.

FIG. 7B is another illustration of a wireless network that can implement MBMS/eMBMS as disclosed herein.

FIG. 8 illustrates an exemplary wireless network that can expand the footprint of a wireless multicast services used for delivering group communications by using low cost local wireless networks.

FIG. 9 illustrates an exemplary flow for expanding the footprint of a wireless multicast services used for delivering group communications by using low cost local wireless networks.

FIG. 10 illustrates an exemplary flow for using a low cost local wireless network to expand a coverage area of a wireless multicast service.

FIG. 11 illustrates an exemplary flow for using a low cost local wireless network to expand a coverage area of a wireless multicast service.

FIG. 12 illustrates a communication device that includes logic configured to perform functionality in accordance with an embodiment of the disclosure.

### DETAILED DESCRIPTION

Aspects of the disclosure are disclosed in the following description and related drawings directed to specific embodiments of the disclosure. Alternate embodiments may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any embodiment described herein as “exemplary” and/or “example” is not necessarily to be construed as preferred or advantageous over other embodiments. Likewise, the term “embodiments of the disclosure” does not require that all embodiments of the disclosure include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

A High Data Rate (HDR) subscriber station, referred to herein as an access terminal (AT), may be mobile or stationary, and may communicate with one or more HDR base stations, referred to herein as modem pool transceivers (MPTs) or base stations (BS). An access terminal transmits and receives data packets through one or more modem pool transceivers to an HDR base station controller, referred to as a modem pool controller (MPC), base station controller (BSC) and/or packet control function (PCF). Modem pool transceivers and modem pool controllers are parts of a network called an access network. An access network transports data packets between multiple access terminals.

The access network may be further connected to additional networks outside the access network, such as a corporate intranet or the Internet, and may transport data packets between each access terminal and such outside networks. An access terminal that has established an active traffic channel connection with one or more modem pool transceivers is called an active access terminal, and is said to be in a traffic state. An access terminal that is in the process of establishing an active traffic channel connection with one or more modem pool transceivers is said to be in a connection setup state. An access terminal may be any data device that communicates through a wireless channel or through a wired channel, for example using fiber optic or coaxial cables. An access terminal may further be any of a number of types of devices including but not limited to PC card, compact flash, external or internal modem, or wireless or wireline phone. The communication link through which the access terminal sends signals to the modem pool transceiver is called a reverse link or traffic channel. The communication link through which a modem pool transceiver sends signals to an access terminal is called a forward link or traffic channel. As used herein the term traffic channel can refer to either a forward or reverse traffic channel.

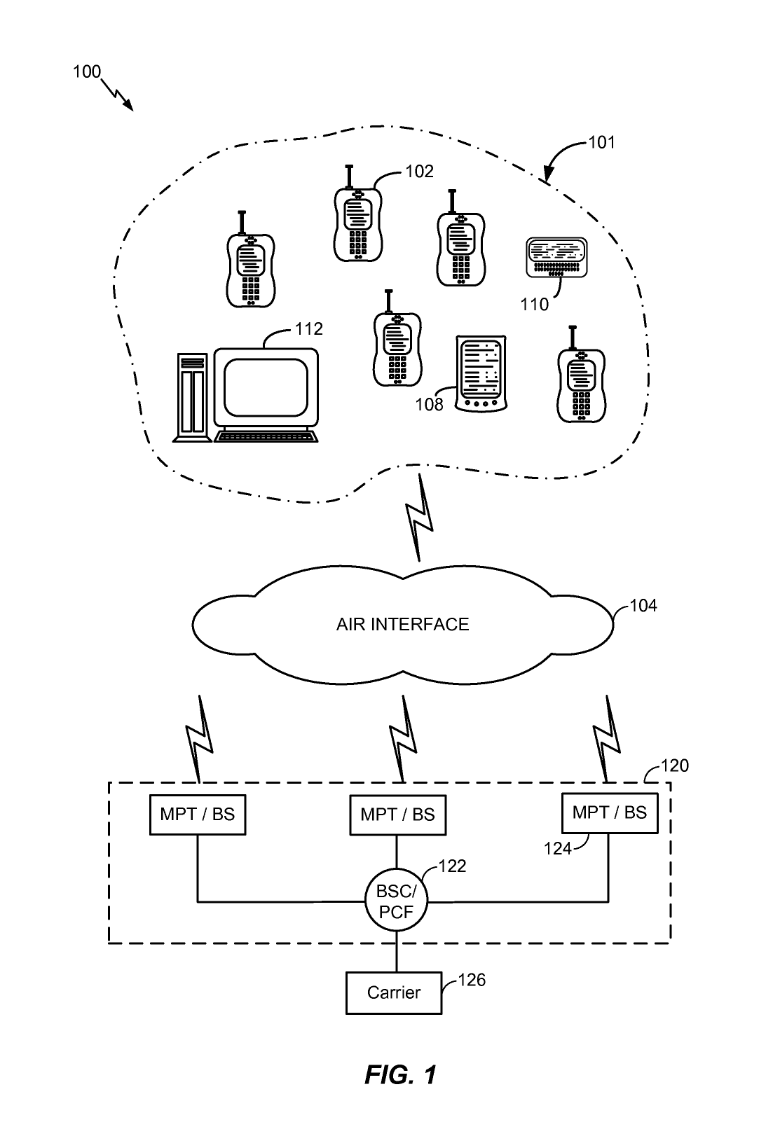

FIG. 1 illustrates a block diagram of one exemplary embodiment of a wireless communications system 100 in accordance with at least one embodiment of the disclosure. Wireless communications system 100 can contain access terminals, such as cellular telephone 102, in communication across an air interface 104 with an access network or radio access network (RAN) 120 that can connect the access terminal 102 to network equipment providing data connectivity between a packet switched data network (e.g., an intranet, the Internet, and/or carrier network 126) and the access terminals 102, 108, 110, 112. As shown here, the access terminal can be a cellular telephone 102, a personal digital assistant 108, a pager 110, which is shown here as a two-way text pager, or even a separate computer platform 112 that has a wireless communication portal. Embodiments of the disclosure can thus be realized on any form of access terminal including a wireless communication portal or having wireless communication capabilities, including without limitation, wireless modems, PCMCIA cards, personal computers, telephones, or any combination or sub-combination thereof. Further, as used herein, the terms “access terminal”, “wireless device”, “client device”, “mobile terminal” and variations thereof may be used interchangeably.

Referring back to FIG. 1, the components of the wireless communications system 100 and interrelation of the elements of the exemplary embodiments of the disclosure are not limited to the configuration illustrated. Wireless communications system 100 is merely exemplary and can include any system that allows remote access terminals, such as wireless client computing devices 102, 108, 110, 112 to communicate over-the-air between and among each other and/or between and among components connected via the air interface 104 and RAN 120, including, without limitation, carrier network 126, the Internet, and/or other remote servers.

The RAN 120 controls messages (typically sent as data packets) sent to a base station controller/packet control function (BSC/PCF) 122. The BSC/PCF 122 is responsible for signaling, establishing, and tearing down bearer channels (i.e., data channels) between a packet data service node (“PDSN”) and the access terminals 102/108/110/112. If link layer encryption is enabled, the BSC/PCF 122 also encrypts the content before forwarding it over the air interface 104. The function of the BSC/PCF 122 is well-known in the art and will not be discussed further for the sake of brevity. The carrier network 126 may communicate with the BSC/PCF 122 by a network, the Internet and/or a public switched telephone network (PSTN). Alternatively, the BSC/PCF 122 may connect directly to the Internet or external network. Typically, the network or Internet connection between the carrier network 126 and the BSC/PCF 122 transfers data, and the PSTN transfers voice information. The BSC/PCF 122 can be connected to multiple base stations (BS) or modem pool transceivers (MPT) 124. In a similar manner to the carrier network, the BSC/PCF 122 is typically connected to the MPT/BS 124 by a network, the Internet and/or PSTN for data transfer and/or voice information. The MPT/BS 124 can broadcast data messages wirelessly to the access terminals, such as cellular telephone 102. The MPT/BS 124, BSC/PCF 122 and other components may form the RAN 120, as is known in the art. However, alternate configurations may also be used and the disclosure is not limited to the configuration illustrated. For example, in another embodiment the functionality of the BSC/PCF 122 and one or more of the MPT/BS 124 may be collapsed into a single “hybrid” module having the functionality of both the BSC/PCF 122 and the MPT/BS 124.

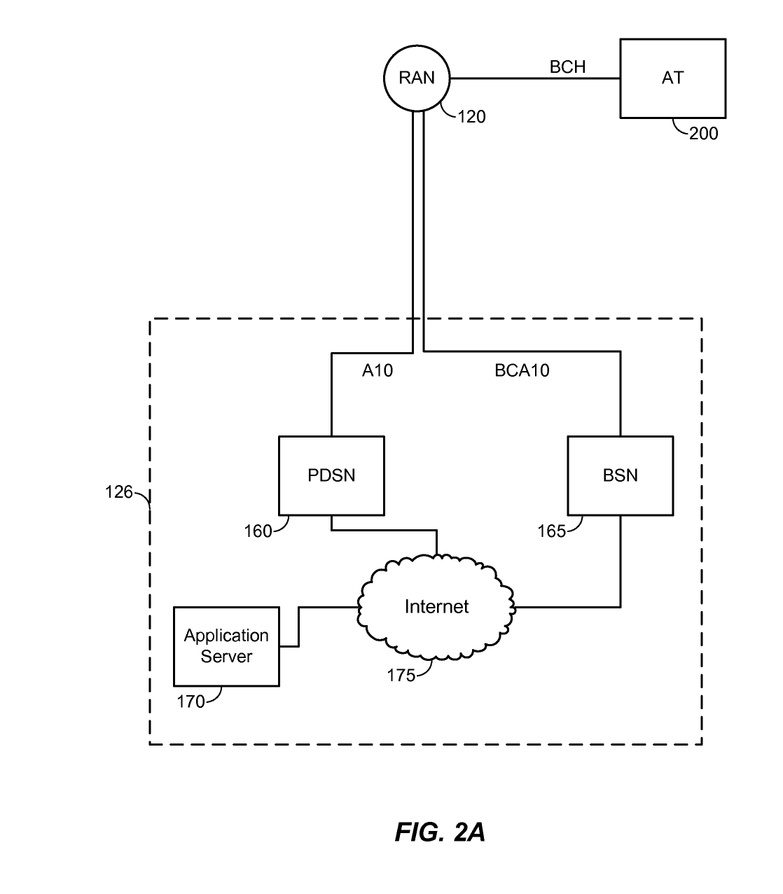

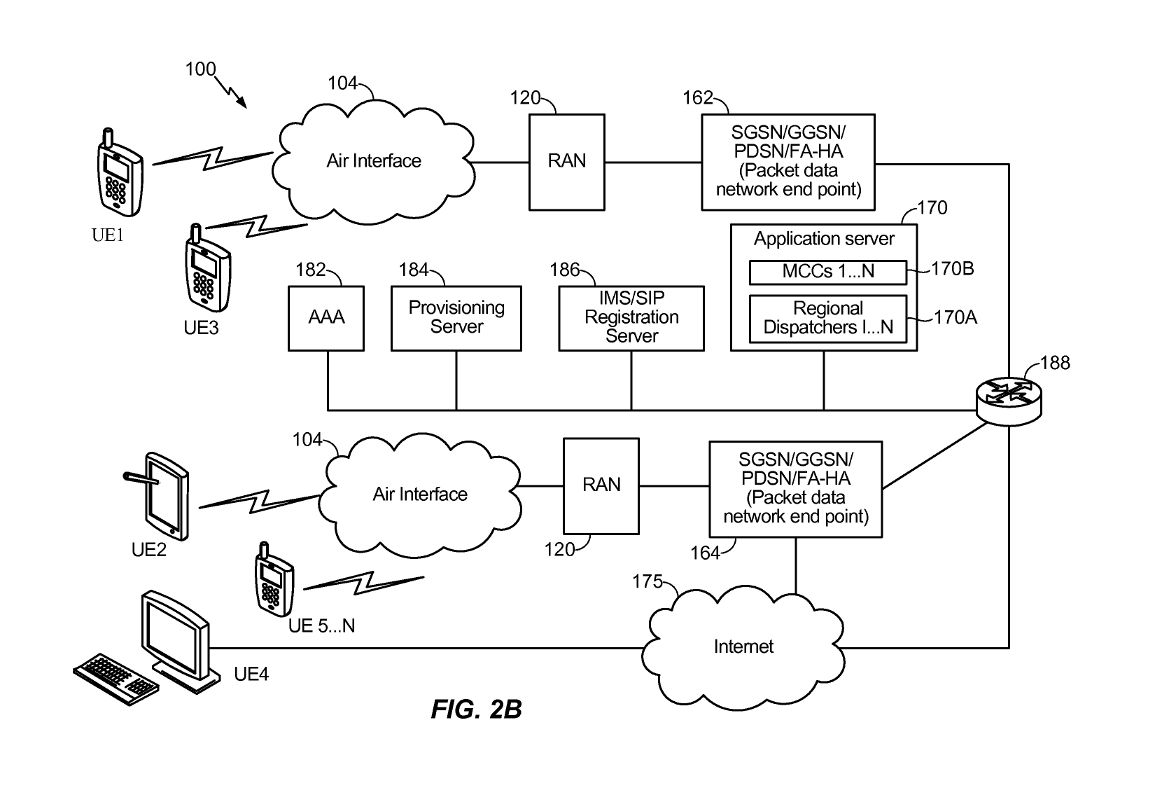

FIG. 2A illustrates the carrier network 126 according to an embodiment of the present disclosure. In the embodiment of FIG. 2A, the carrier network 126 includes a packet data serving node (PDSN) 160, a broadcast serving node (BSN) 165, an application server 170 and an Internet 175. However, application server 170 and other components may be located outside the carrier network in alternative embodiments. The PDSN 160 provides access to the Internet 175, intranets and/or remote servers (e.g., application server 170) for mobile stations (e.g., access terminals, such as 102, 108, 110, 112 from FIG. 1) utilizing, for example, a cdma2000 Radio Access Network (RAN) (e.g., RAN 120 of FIG. 1). Acting as an access gateway, the PDSN 160 may provide simple IP and mobile IP access, foreign agent support, and packet transport. The PDSN 160 can act as a client for Authentication, Authorization, and Accounting (AAA) servers and other supporting infrastructure and provides mobile stations with a gateway to the IP network as is known in the art. As shown in FIG. 2A, the PDSN 160 may communicate with the RAN 120 (e.g., the BSC/PCF 122) via a conventional A10 connection. The A10 connection is well-known in the art and will not be described further for the sake of brevity.

Referring to FIG. 2A, the broadcast serving node (BSN) 165 may be configured to support multicast and broadcast services. The BSN 165 will be described in greater detail below. The BSN 165 communicates with the RAN 120 (e.g., the BSC/PCF 122) via a broadcast (BC) A10 connection, and with the application server 170 via the Internet 175. The BCA10 connection is used to transfer multicast and/or broadcast messaging. Accordingly, the application server 170 sends unicast messaging to the PDSN 160 via the Internet 175, and sends multicast messaging to the BSN 165 via the Internet 175.

Generally, as will be described in greater detail below, the RAN 120 transmits multicast messages, received from the BSN 165 via the BCA10 connection, over a broadcast channel (BCH) of the air interface 104 to one or more access terminals 200.

FIG. 2B illustrates an example of the wireless communication system 100 of FIG. 1 in more detail. In particular, referring to FIG. 2B, ATs 1 . . . N are shown as connecting to the RAN 120 at locations serviced by different packet data network end-points. Accordingly, ATs 1 and 3 connect to the RAN 120 at a portion served by a first packet data network end-point 162 (e.g., which may correspond to PDSN 160, BSN 165, a home agent (HA), a foreign agent (FA), etc.). The first packet data network end-point 162 in turn connects, via the routing unit 188, to the Internet 175 and/or to one or more of an authentication, authorization and accounting (AAA) server 182, a provisioning server 184, an Internet Protocol (IP) Multimedia Subsystem (IMS)/Session Initiation Protocol (SIP) Registration Server 186 and/or the application server 170. ATs 2 and 5 . . . N connect to the RAN 120 at a portion served by a second packet data network end-point 164 (e.g., which may correspond to PDSN 160, BSN 165, FA, HA, etc.). Similar to the first packet data network end-point 162, the second packet data network end-point 164 in turn connects, via the routing unit 188, to the Internet 175 and/or to one or more of the AAA server 182, a provisioning server 184, an IMS/SIP Registration Server 186 and/or the application server 170. AT 4 connects directly to the Internet 175, and through the Internet 175 can then connect to any of the system components described above.

Referring to FIG. 2B, ATs 1, 3 and 5 . . . N are illustrated as wireless cell-phones, AT 2 is illustrated as a wireless tablet-PC and AT 4 is illustrated as a wired desktop station. However, in other embodiments, it will be appreciated that the wireless communications system 100 can connect to any type of AT, and the examples illustrated in FIG. 2B are not intended to limit the types of ATs that may be implemented within the system. Also, while the AAA server 182, the provisioning server 184, the IMS/SIP registration server 186 and the application server 170 are each illustrated as structurally separate servers, one or more of these servers may be consolidated in at least one embodiment of the disclosure.

Further, referring to FIG. 2B, the application server 170 is illustrated as including a plurality of media control complexes (MCCs) 1 . . . N 170B, and a plurality of regional dispatchers 1 . . . N 170A. Collectively, the regional dispatchers 170A and MCCs 170B are included within the application server 170, which in at least one embodiment can correspond to a distributed network of servers that collectively functions to arbitrate communication sessions (e.g., half-duplex group communication sessions via IP unicasting and/or IP multicasting protocols) within the wireless communications system 100. For example, because the communication sessions arbitrated by the application server 170 can theoretically take place between ATs located anywhere within the wireless communications system 100, multiple regional dispatchers 170A and MCCs are distributed to reduce latency for the arbitrated communication sessions (e.g., so that a MCC in North America is not relaying media back-and-forth between session participants located in China). Thus, when reference is made to the application server 170, it will be appreciated that the associated functionality can be enforced by one or more of the regional dispatchers 170A and/or one or more of the MCCs 170B. The regional dispatchers 170A are generally responsible for any functionality related to establishing a communication session (e.g., handling signaling messages between the ATs, scheduling and/or sending announce messages, etc.), whereas the MCCs 170B are responsible for hosting the communication session for the duration of the call instance, including conducting an in-call signaling and an actual exchange of media during an arbitrated communication session.

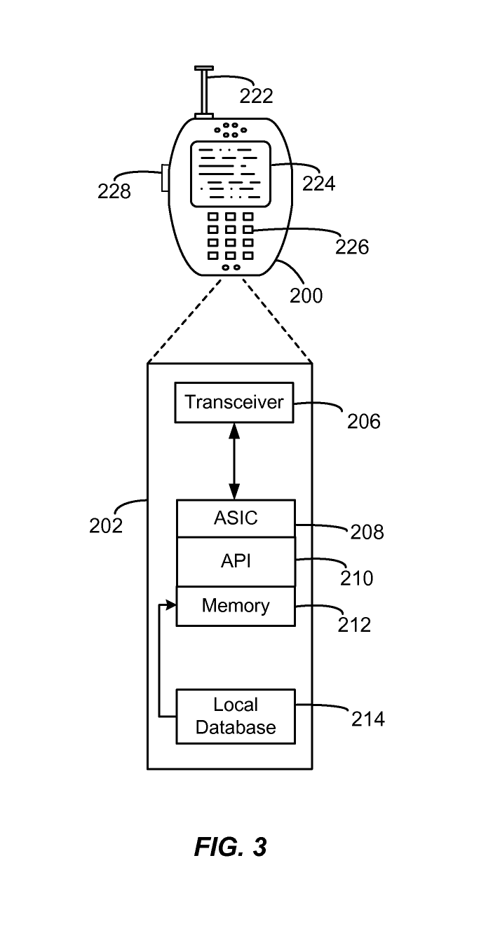

Referring to FIG. 3, a UE 200, (here a wireless device), such as a cellular telephone, has a platform 202 that can receive and execute software applications, data and/or commands transmitted from the RAN 120 that may ultimately come from the carrier network 126, the Internet and/or other remote servers and networks. The platform 202 can include a transceiver 206 operably coupled to an application specific integrated circuit (“ASIC” 208), or other processor, microprocessor, logic circuit, or other data processing device. The ASIC 208 or other processor executes the application programming interface (“API’) 210 layer that interfaces with any resident programs in the memory 212 of the wireless device. The memory 212 can be comprised of read-only or random-access memory (RAM and ROM), EEPROM, flash cards, or any memory common to computer platforms. The platform 202 also can include a local database 214 that can hold applications not actively used in memory 212. The local database 214 is typically a flash memory cell, but can be any secondary storage device as known in the art, such as magnetic media, EEPROM, optical media, tape, soft or hard disk, or the like. The internal platform 202 components can also be operably coupled to external devices such as antenna 222, display 224, push-to-talk button 228 and keypad 226 among other components, as is known in the art.

Accordingly, an embodiment of the disclosure can include an access terminal including the ability to perform the functions described herein. As will be appreciated by those skilled in the art, the various logic elements can be embodied in discrete elements, software modules executed on a processor or any combination of software and hardware to achieve the functionality disclosed herein. For example, ASIC 208, memory 212, API 210 and local database 214 may all be used cooperatively to load, store and execute the various functions disclosed herein and thus the logic to perform these functions may be distributed over various elements. Alternatively, the functionality could be incorporated into one discrete component. Therefore, the features of the access terminal in FIG. 3 are to be considered merely illustrative and the disclosure is not limited to the illustrated features or arrangement.

The wireless communication between the access terminal 102 and the RAN 120 can be based on different technologies, such as code division multiple access (CDMA), WCDMA, time division multiple access (TDMA), frequency division multiple access (FDMA), Orthogonal Frequency Division Multiplexing (OFDM), the Global System for Mobile Communications (GSM), or other protocols that may be used in a wireless communications network or a data communications network. The data communication is typically between the client device 102, MPT/BS 124, and BSC/PCF 122. The BSC/PCF 122 can be connected to multiple data networks such as the carrier network 126, PSTN, the Internet, a virtual private network, and the like, thus allowing the access terminal 102 to access to a broader communication network. As discussed in the foregoing and known in the art, voice transmission and/or data can be transmitted to the access terminals from the RAN using a variety of networks and configurations. Accordingly, the illustrations provided herein are not intended to limit the embodiments of the disclosure and are merely to aid in the description of aspects of embodiments of the disclosure.

Access terminals can be configured to connect to servers, such as the application server 170, through one of a plurality of systems or networks. For example, a given access terminal can connect to the application server 170 via a WiFi system (e.g., 802.11a/b, etc.), a CDMA2000 1x system, a Wideband CDMA (WCDMA) system, a FDMA system, a TDMA system, a OFDM system, a long-term evolution (LTE) system, a BCMCS system by which the RAN 120 transmits messages to multiple ATs within a given sector on a shared downlink channel, such as a broadcast channel (BCH), a multimedia broadcast/multicast services (MBMS) system and/or a unicast 1x EV-DO system by which the RAN 120 transmits messages to a single AT on a downlink dedicated channel (DCH) or unicast channel. Accordingly, the term ‘system’ as used herein, in the context of providing service to an access terminal through the RAN 120, corresponds to any type of wireless technology through which the access terminal can establish a link to other network components, such as the application server 170.

The access terminal can setup a communication session (e.g., a push-to-talk (PTT) session, a VoIP session, a half-duplex session, a full-duplex session, etc.) on a first system, and can later switch from the first system to a second system without terminating the communication session. This type of switch can be referred to as an inter-system handover or handoff. An inter-system handoff of the access terminal between systems (e.g., EV-DO, 1x, BCMCS, cdma2000 1X, etc.) should not be confused with a handoff of the access terminal from one serving area (e.g., a cell, sector, subnet, etc.) to another serving area. In other words, the access terminal can handoff from one type of system providing service to another type of system, and the access terminal can also (separately) handoff from one service area for a particular system to another service area for the same system. Embodiments of the disclosure are generally directed to inter-system handoff, although this does not preclude a serving-area handoff from occurring in conjunction with the embodiments described herein.

Handoffs of the access terminal from one system (e.g., BCMCS) to another system (e.g., 1x, unicast EV-DO, etc.) are conventionally controlled at the AT with software that operates at a lower-layer, such as the physical layer. This software construct may be referred to as a lower layer controller, and may be stored in memory 212 and executed by the ASIC 208. In an example, the lower layer controller can base handoff-decisions on physical layer parameters, such as frame-error-rate (FER), pilot signal strength, detection of a new system, etc. Generally, this means the lower layer controller evaluates how well packets containing data are exchanged on a packet-by-packet or physical frame-by-frame basis, without taking into account the higher-level or application-layer uses of the actual data. Furthermore, inter-system handoff generally requires complex signaling exchanges between the AT and the RAN 120 in order to command the related measurements, report the results, and transmit handoff commands in a seamless manner.

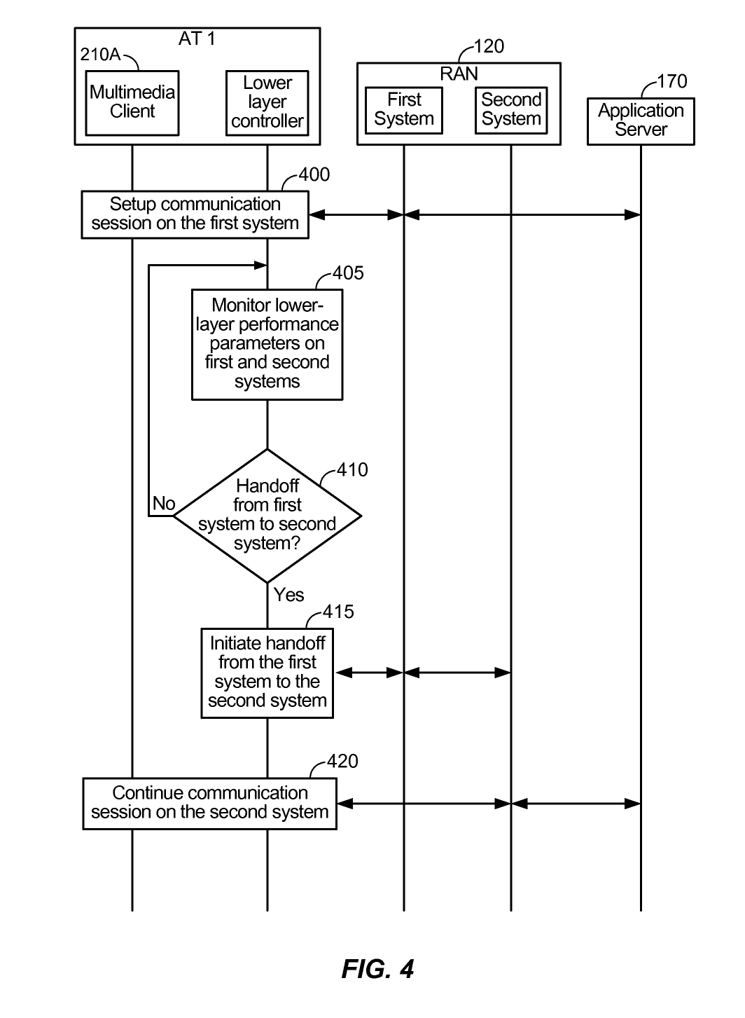

FIG. 4 illustrates a conventional inter-system handoff of a given access terminal (“AT 1”) that is participating in a wireless communication session. Referring to FIG. 4, assume that AT 1 is configured to connect to the RAN 120 on either a first system or a second system. For convenience of explanation, assume that the first system corresponds to generally to EV-DO and the second system corresponds to BCMCS.

Referring to FIG. 4, AT 1 sets up a communication session on the first system, 400. For example, if the communication session corresponds to a PTT session originated by AT 1, a multimedia client 210A that is responsible for managing AT 1's PTT session at the application-layer receives an indication that a user of AT 1 has pushed a PTT button. The multimedia client 210A then requests the lower layer controller to schedule and send a call message to the application server 170. After obtaining or waiting for the requisite call resources, the lower layer controller sends the call message to the RAN 120 (e.g., on a reverse link access channel or a R-TCH), which is forwarded to the application server 170, which announces the session to one or more target ATs and then sends a floor-grant to AT 1 after at least one target AT accepts the announced session.

While the communication session is conducted on the first system, the lower layer controller monitors one or more lower-layer performance parameters associated with the communication session, 405. For example, the one or more lower-layer performance parameters may include a frame-error-rate (FER) for packets associated with the communication session. Alternatively or additionally, the lower layer controller may monitor a pilot signal strength of the first system.

Based on the monitored one or more lower-layer performance parameters, the lower layer controller determines whether to trigger a handoff of AT 1 from the first system to the second system, 410. For example, if the lower layer controller is configured to make handoff decisions between systems for AT 1 based on FER, then the decision of 410 may correspond to comparing a current FER or running-average FER for AT 1's communication session on the first system with a threshold FER, and then selectively triggering a handoff if the current or running-average FER is higher than the threshold FER.

If the lower layer controller of AT 1 determines not to handoff to the second system in 410, the process returns to 405 and AT 1 continues to monitor the one or more lower-layer performance parameters while the communication session continues on the first system. Otherwise, if the lower layer controller of AT 1 determines to handoff to the second system in 410, the lower layer controller initiates or triggers the handoff of AT 1 from the first system to the second system, as is known in the art, 415. For example, if the first system is BCMCS and the second system is unicast EV-DO, then the handoff to the second system may include requesting a unicast TCH and de-registering with the RAN 120 for multicast support via BCMCS. The particular signaling that occurs to facilitate the handoff in 415 is not shown because this signaling can be different for handoffs between different systems of the RAN 120 (e.g., EV-DO to 1x, BCMCS to unicast EV-DO, unicast EV-DO to WiFi, etc.). After completing the handoff that is initiated in 415, AT 1 continues the communication session on the second system, if possible, 420.

It should be noted that many systems do not support inter-system lower layer signaling. Even if such systems do, inter-system handoff is conventionally restricted to/from a restricted set of systems. For these reasons, supporting the inter-system handoff at the lower layer can require significant enhancements to the existing systems. On the other hand, the application-initiated inter-system handoff can be implemented using existing layer signaling messages without requiring any system enhancements. Specific mechanisms for initiating the inter-system handoff at the application layer will be elaborated later.

As will be appreciated by one of ordinary skill in the art, the process of FIG. 4 can potentially permit AT 1 to handoff to another system with superior physical-layer performance characteristics in the event of physical-layer performance degradation on a current system. In the absence of lower layer support, it is possible that the degraded performance related to the communication session at the application-level and the existence of an alternative system can trigger an application-driven inter-system handoff. For example, the communication session may undergo a relatively high media-error-rate (MER) and/or outage duration (OD), which occurs at the application-level. If the application finds availability of an alternative/second system, the application may attempt to handoff to the second system. In another example, if an access terminal is supported by a system with a higher charging rate than another available system (e.g., the AT is connected to a cellular network and hands off to a roaming service area, a free WiFi connection becomes available while the AT is connected to an in-network cellular system that is costing a user thereof usage minutes, etc.), the user thereof may wish to handoff to the cheaper system. Accordingly, embodiments of the disclosure are generally directed to making system handoff decisions based on one or more application-layer criteria either in place of or in addition to lower-layer (e.g., physical-layer) considerations as in FIG. 4.

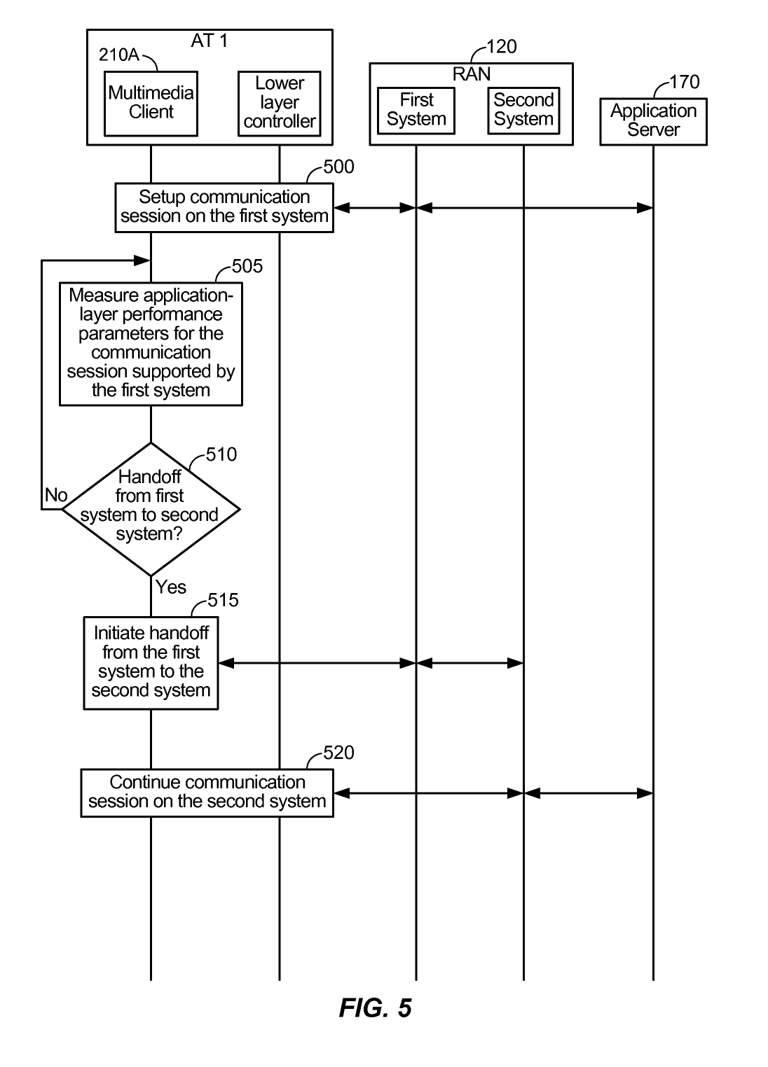

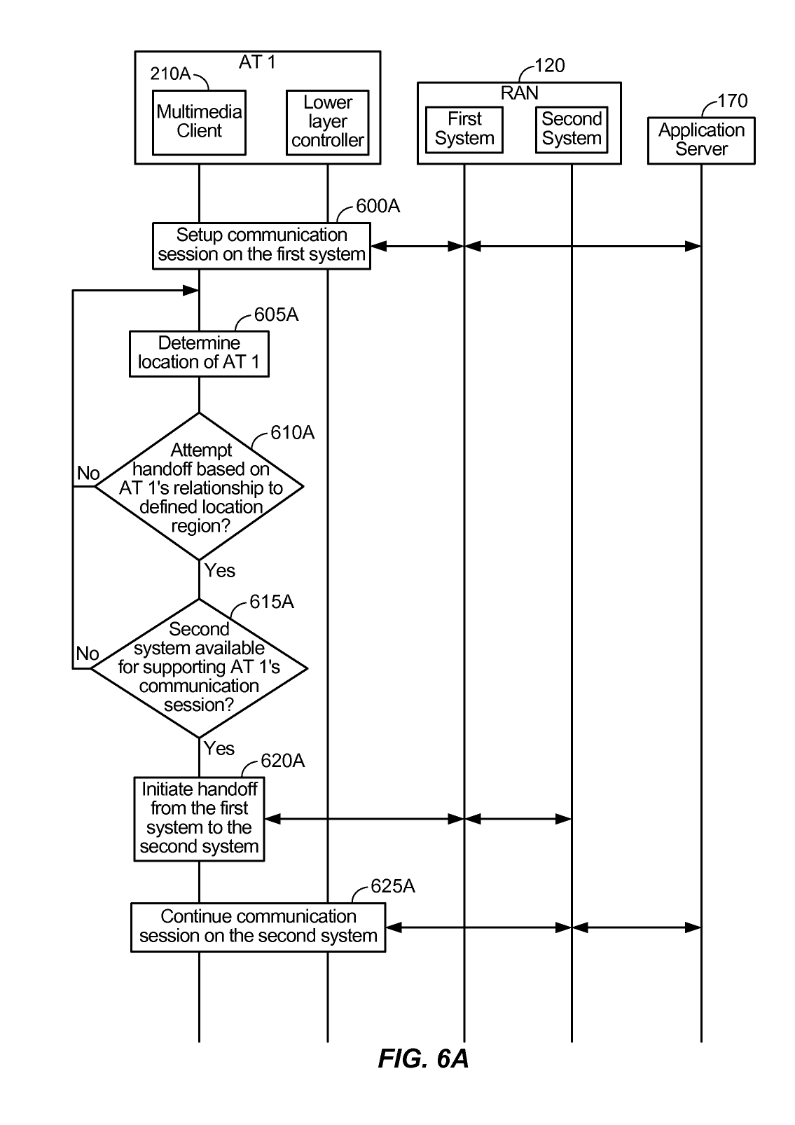

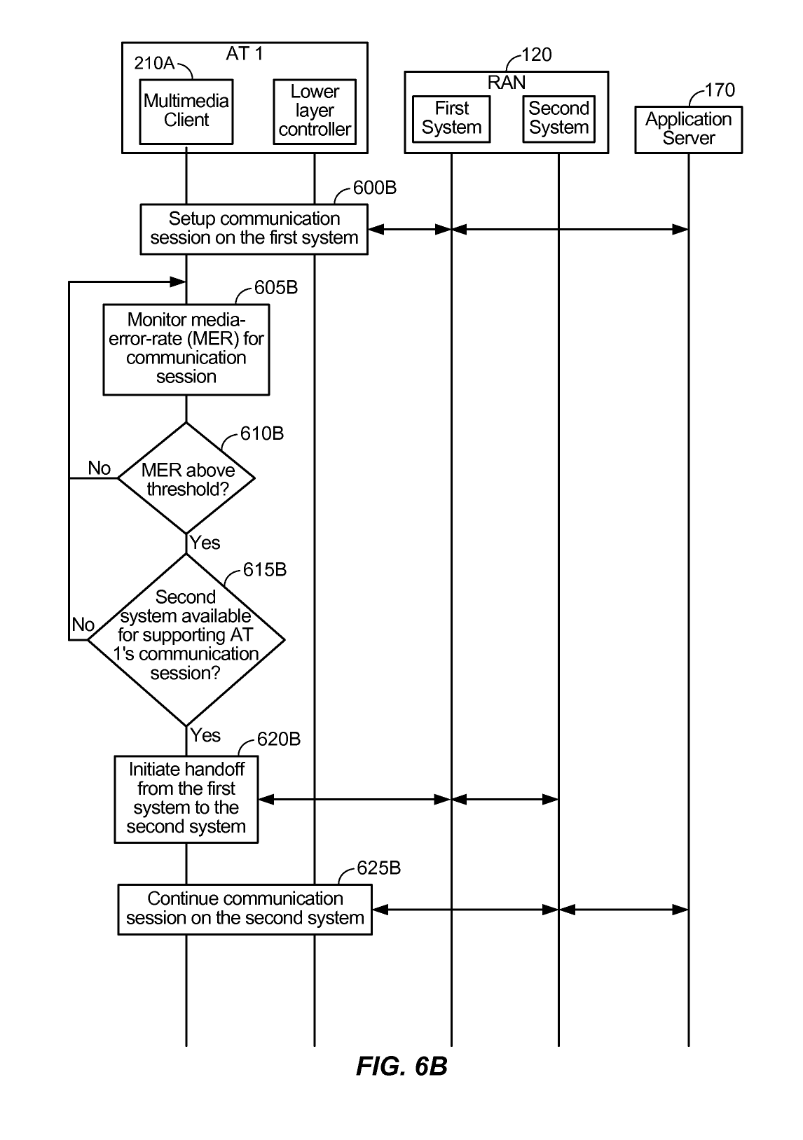

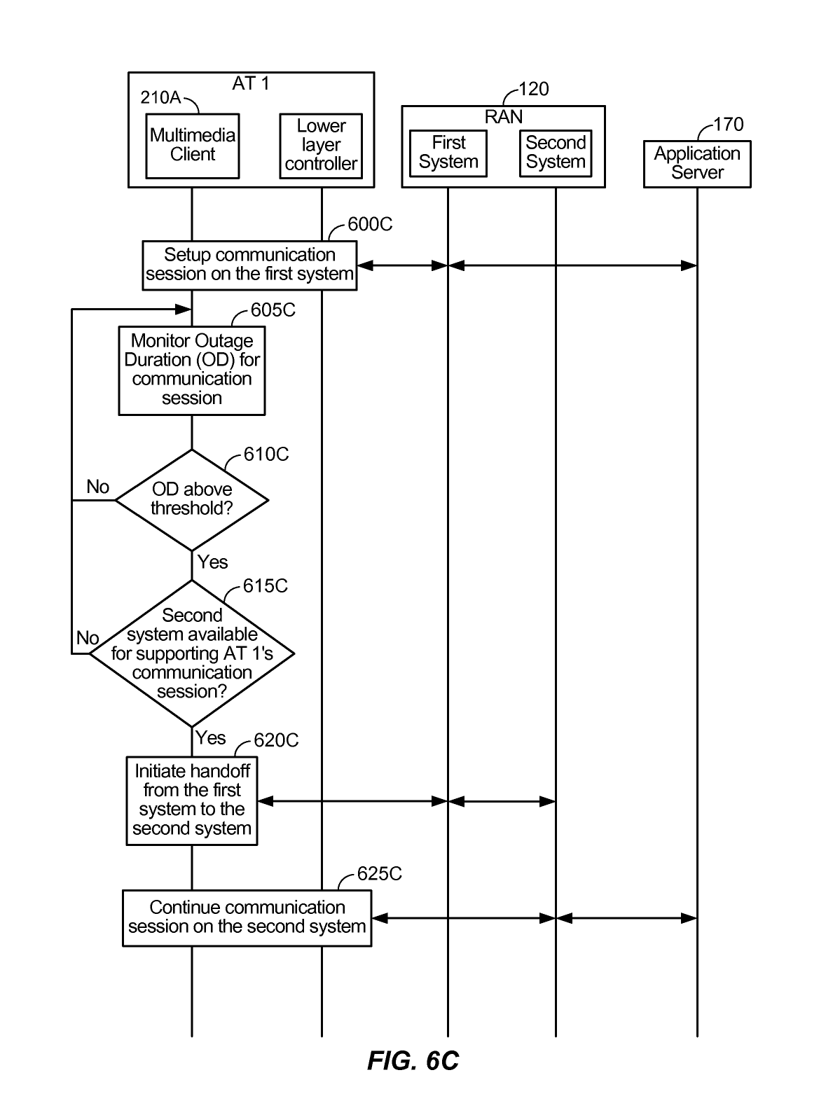

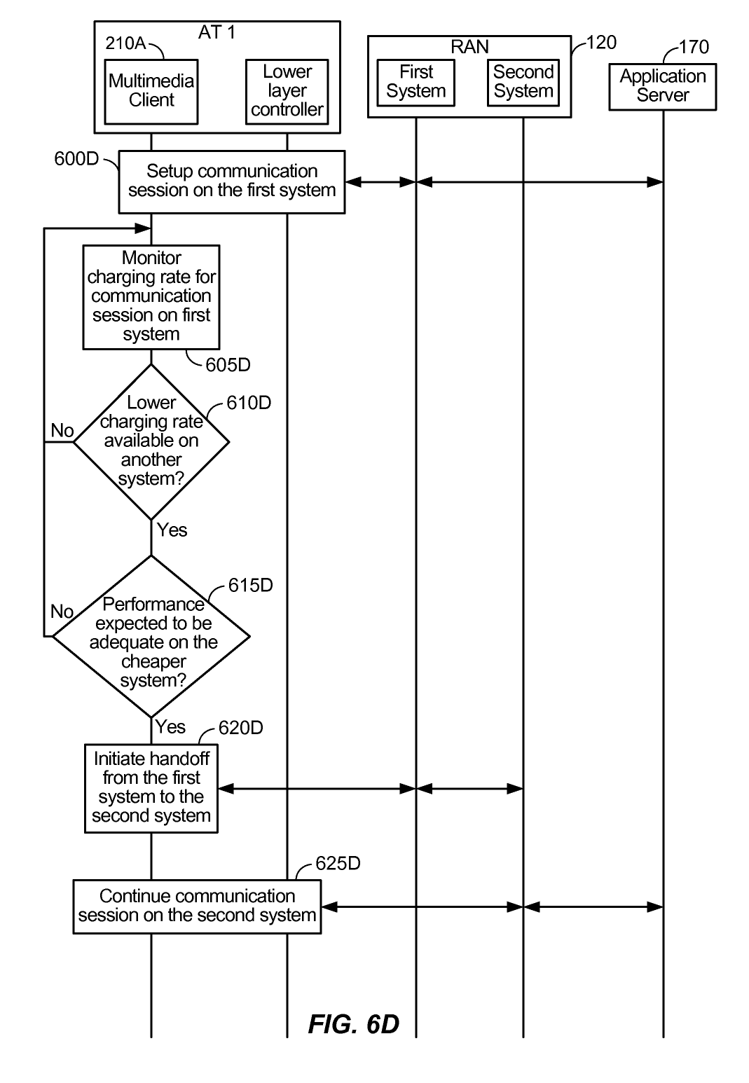

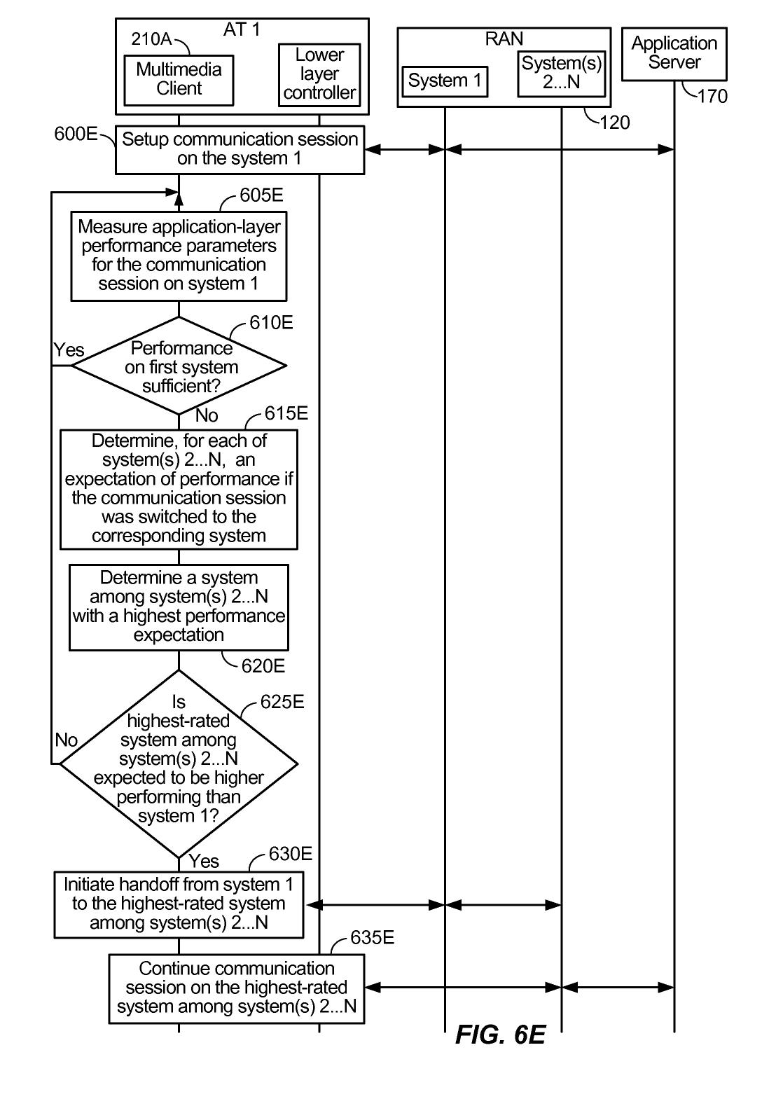

FIG. 5 illustrates a system-handoff of a given access terminal (“AT 1”) that is participating in a wireless communication session in accordance with an embodiment of the disclosure. In particular, FIG. 5 illustrates the inventive inter-system handoff process at a relatively high level, with examples of more detailed implementations provided afterwards with respect to FIGS. 6A through 6E. Referring to FIG. 5, assume that AT 1 is configured to connect to the RAN 120 on at least two systems or wireless connection technologies (e.g., EV-DO, BCMCS, 1x, WiFi, Bluetooth, etc.).

Referring to FIG. 5, AT 1 sets up a communication session on the first system, 500. For example, if the communication session corresponds to a PTT session originated by AT 1, a multimedia client 210A that is responsible for managing AT 1's PTT session at the application-layer receives an indication that a user of AT 1 has pushed a PTT button. The multimedia client 210A then requests the lower layer controller to schedule and send a call message to the application server 170. After obtaining or waiting for the requisite call resources, the lower layer controller sends the call message to the RAN 120 (e.g., on a reverse link access channel or a R-TCH), which is forwarded to the application server 170, which announces the session to one or more target ATs and then sends a floor-grant to AT 1 after at least one target AT accepts the announced session.

While not illustrated in FIG. 5, while the communication session is conducted on the first system, the lower layer controller can monitor one or more lower-layer performance parameters associated with the communication session as in FIG. 4, and the lower layer controller can initiate handoffs based on the lower-layer or physical-layer performance of the different systems. However, in FIG. 5, performance at the physical-layer need not be the only type of performance considered in determining whether to handoff from one system to another.

Accordingly, the multimedia client 210A measures one or more application-layer performance parameters for the communication system that is being supported by the first system of the RAN 120, 505. For example, the one or more application-layer performance parameters can include (i) a media-error-rate (MER) of the communication session (e.g., based on a success rate of audio frames if the communication session is an audio session, based on a success rate of video and/or audio frames if the communication session is a video conference), (ii) an outage duration (OD) of the communication session (e.g., a period of downlink inactivity due to successive media errors on the communication session), (iii) a rate at which the first system is currently charging a user of AT 1 for usage related to the communication session), (iv) the multimedia client's 210A status as floor-holder or listener if the communication corresponds to a half-duplex PTT session, (v) a priority of the user of AT 1 (e.g., such that a priority of a user of AT 1 is evaluated, and a handoff to a system with superior application-layer performance is only performed if the user's priority is sufficient to permit using the target system for a current application), and/or (vi) any combination thereof.

Based on the monitored one or more application-layer performance parameters, the multimedia client 210A determines whether to trigger a handoff of AT 1 from the first system to the second system, 510. The determination of 510 may not only be based upon the application-layer performance parameter(s) for the communication session on the first system, but can also be based on the availability of one or more other systems, an expected application-layer performance of any available systems, etc. Examples of the application-layer system handoff decision block of 510 are given below with respect to FIGS. 6A through 6E.

If the multimedia client 210A of AT 1 determines not to handoff to the second system in 510, the process returns to 505 and AT 1 continues to monitor the one or more lower-layer performance parameters while the communication session continues on the first system. Otherwise, if the multimedia client 210A of AT 1 determines to handoff to the second system in 510, the multimedia client 210A initiates or triggers the handoff of AT 1 from the first system to the second system, as is known in the art, 515. In general, the signaling that occurs to facilitate the handoff in 515 includes releasing the connection with the first system and establishing the connection with the second system. This is not shown explicitly in FIG. 5 because this signaling can be different for different systems of the RAN 120 (e.g., EV-DO to 1x, BCMCS to unicast EV-DO, unicast EV-DO to WiFi, etc.). After completing the handoff that is initiated in 515, AT 1 continues the communication session on the second system, if possible, 520.

As will be appreciated by one of ordinary skill in the art from a review of FIG. 5, the multimedia client 210A has access to higher-level information regarding the communication session as compared to the lower layer controller. As such, the multimedia client 210A can potentially be in a better position to evaluate whether a system handoff is called for by taking into account performance of the communication session at the application layer, and not merely the physical layer. More detailed implementation examples of the process of FIG. 5 will now be provided with respect to FIGS. 6A through 6E.

FIG. 6A illustrates the system-handoff process of FIG. 5 whereby one application-layer performance parameter corresponds to a location of AT 1 within the wireless communications system 10 in accordance with an embodiment of the disclosure.

Referring to FIG. 6A, AT 1 sets up a communication session on the first system, 600A, as described above with respect to 500 of FIG. 5. In 605A, the multimedia client 210A determines location information associated with AT 1. The location information may correspond to a base station currently serving AT 1, a geographic coordinate of AT 1 (e.g., a GPS coordinate), and/or any other manner of identifying AT 1's location. In 610A, the multimedia client 210A compares AT 1's location information with a defined location region of the system 10. In an example, the defined location region corresponds to a list of sectors, such that if AT 1's current sector from 605A is in the list of sectors the multimedia client 210A can infer whether a particular system (e.g., unicast EV-DO, BCMCS, etc.) is available and/or permitted for use by AT 1. Defined location regions and methodologies for determining location information is described in more detail within co-pending U.S. Provisional Patent Application No. 61/163,834, entitled “REGULATING THE SCOPE OF SERVICE GEOGRAPHICALLY IN WIRELESS NETWORKS”, filed on Mar. 26, 2009, assigned to the same assignee of the subject application, and hereby incorporated by reference in its entirety.

Accordingly, in the example of FIG. 6A, the one or more measured application-layer performance parameters includes some type of location information associated with AT 1. If the location comparison of 610A indicates that AT 1 is inside of or outside of the defined location region, the multimedia client 210A may determine whether to attempt a handoff to another system. For example, the defined location region may indicate sectors that are configured to support AT 1's communication session on the first system, such that if AT 1 now determines itself to be outside of the defined location region, the multimedia client 210A knows that a handoff to another system needs to be made or else the communication session is going to be dropped. In another example, the defined location region may indicate sectors where a more desirable system (“second system”) than the first system is available for supporting AT 1's communication session. In a further example, the first system may correspond to BCMCS for supporting a group communication session via IP multicasting protocols within the EV-DO network of the RAN 120, and the second system may correspond to unicast EV-DO for supporting the group communication session via IP unicasting protocols within the EV-DO network of the RAN 120 (or vice versa).

Based on the relationship between AT 1's location information from 605A and the defined location region, the multimedia client 210A either continues to monitor the location of AT 1 during the communication session on the first system and returns to 605A, or else advances to 615A. In 615A, AT 1 determines whether a second system is available for supporting AT 1's communication session with a level of application-layer performance expected to be higher than the first system. In an example, the presence of the second system can be inferred from AT 1's relationship to the defined location region. If no second system is determined to be available for supporting AT 1's communication session in 615A, the process returns to 605A and AT 1 continues to monitor AT 1's location during the communication session on the first system. Otherwise, if the second system associated with a higher expected level of application-layer performance is determined to be available in 615A, the multimedia client 210A initiates or triggers the handoff of AT 1 from the first system to the second system, as is known in the art, 620A. After completing the handoff that is initiated in 620A, AT 1 continues the communication session on the second system, if possible, 625A. Accordingly, the embodiment of FIG. 6A illustrates one manner by which location of an access terminal can be used to determine when to perform inter-system handoffs of the access terminal.

Referring to FIG. 6A, each time AT 1 re-determines its location of AT 1 in 605A, the decision logic associated with blocks 610A and 615A may use AT 1's newly acquired location to determine whether or not to perform an inter-system handoff. In an example, each iteration of AT 1 determining its location can be timer-based (i.e., performed at a given period), or event based, or a combination thereof. In an example, events that may trigger AT 1 to determine its location may include a media-error-rate (MER) for the communication session on a current system rising above a threshold, when AT 1 hands off to a new cell or sector (e.g., such as when a Broadcast Multicast Service (BCMCS) flow status reported by AT 1 becoming unavailable as the AT enters a sector that does not broadcast the desired BCMCS flow) and/or any other potential event that has the potential to affect system performance and/or availability.

FIG. 6B illustrates the system-handoff process of FIG. 5 whereby one application-layer performance parameter corresponds to a media error rate (MER) for AT 1's communication session within the wireless communications system 10 in accordance with an embodiment of the disclosure.

Referring to FIG. 6B, AT 1 sets up a communication session on the first system, 600B, as described above with respect to 500 of FIG. 5. In 605B, the multimedia client 210A monitors the MER for the communication session on the first system. For example, the monitored MER may correspond to a time-averaged indication of the number of errors experienced by the multimedia client 210A. As will be appreciated by one of ordinary skill in the art, the MER differs from the FER because the FER is measured at the physical-layer, whereas the MER is measured at the application-layer. Thus, the MER is based on whether errors are experienced in the actual media being played by the multimedia client 210A on AT 1, for example, whereas the FER is based on frame-decoding errors of individual transport packets.

After determining the MER for the communication session on the first system in 605B, the multimedia client 210A compare AT 1's MER with an MER threshold, 610B. If AT 1's MER is determined to be lower than the MER threshold in 610B, the process returns to 605B and the multimedia client 210A continues to monitor the MER during the communication session on the first system. Otherwise, if AT 1's MER is determined to be greater than or equal to the MER threshold in 610B, AT 1 determines whether a second system is available for supporting AT 1's communication session with a level of application-layer performance expected to be higher than the first system, 615B. In the example of FIG. 6B, this means a system that is expected to provide a MER that is lower than the MER threshold, or at least lower than the MER associated with the first system for AT 1's communication session.

If no second system is determined to be available for supporting AT 1's communication session in 615B, the process returns to 605B and AT 1 continues to monitor the MER during the communication session on the first system. Otherwise, if the second system associated with a higher expected level of application-layer performance is determined to be available in 615B, the multimedia client 210A initiates or triggers the handoff of AT 1 from the first system to the second system, as is known in the art, 620B. After completing the handoff that is initiated in 620B, AT 1 continues the communication session on the second system, if possible, 625B. Accordingly, the embodiment of FIG. 6B illustrates one manner by which MER can be used to determine when to perform inter-system handoffs of the access terminal.

FIG. 6C illustrates the system-handoff process of FIG. 5 whereby one application-layer performance parameter corresponds to an outage duration for AT 1's communication session within the wireless communications system 10 in accordance with an embodiment of the disclosure.

Referring to FIG. 6C, AT 1 sets up a communication session on the first system, 600C, as described above with respect to 500 of FIG. 5. In 605C, the multimedia client 210A monitors the OD for the communication session on the first system. For example, the monitored OD may correspond to a period during which media associated with the communication session is not received from the first system of the RAN 120. In a further example, the OD may correspond to a timer that is reset after each successful application-layer media frame is output by multimedia client 210A (e.g., a video frame, an audio frame, etc.).

After determining the OD for the communication session on the first system in 605C, the multimedia client 210A compare AT 1's OD with an OD threshold, 610C. If AT 1's OD is determined to be lower than the OD threshold in 610C, the process returns to 605C and the multimedia client 210A continues to monitor the OD during the communication session on the first system. Otherwise, if AT 1's OD is determined to be greater than or equal to the OD threshold in 610C, AT 1 determines whether a second system is available for supporting AT 1's communication session with a level of application-layer performance expected to be higher than the first system, 615C. In the example of FIG. 6C, this means a system that is expected to provide an OD that is lower than the OD threshold, or at least lower than the OD associated with the first system for AT 1's communication session.

If no second system is determined to be available for supporting AT 1's communication session in 615C, the process returns to 605C and AT 1 continues to monitor the OD during the communication session on the first system. Otherwise, if the second system associated with a higher expected level of application-layer performance is determined to be available in 615C, the multimedia client 210A initiates or triggers the handoff of AT 1 from the first system to the second system, as is known in the art, 620C. After completing the handoff that is initiated in 620C, AT 1 continues the communication session on the second system, if possible, 625C. Accordingly, the embodiment of FIG. 6C illustrates one manner by which OD can be used to determine when to perform inter-system handoffs of the access terminal.

FIG. 6D illustrates the system-handoff process of FIG. 5 whereby one application-layer performance parameter corresponds to a current rate at which a subscriber using AT 1 is being charged for service related to AT 1's communication session within the wireless communications system 10 in accordance with an embodiment of the disclosure.

Referring to FIG. 6D, AT 1 sets up a communication session on the first system, 600D, as described above with respect to 500 of FIG. 5. In 605D, the multimedia client 210A monitors the current rate at which the subscriber using AT 1 is being charged for service related for the communication session on the first system. For example, if the first system corresponds to the subscriber's home WiFi network which is configured to provide unlimited service for a fixed rate, then the charging rate for AT 1's communication session on the first system may be interpreted as zero. In another example, if the first system corresponds to the subscriber's 1x cellular provider which is configured to provide a certain number of minutes and afterwards charge a fee-per-minute of usage, the charging rate for AT 1's communication session on the first system may be interpreted as either a monetary equivalent of a minute of usage or the fee-per-minute, dependent on how much usage the subscriber has incurred. As will be appreciated, different metering plans associated with system-connectivity mean that the monitored charging rate of 605D can correspond to any of various manners by which subscribers are charged for service.

After determining the charging rate for the communication session on the first system in 605D, the multimedia client 210A compare AT 1's charging rate with a charging rate threshold, 610D. If AT 1's charging rate is determined to be lower than the charging rate threshold in 610D, the process returns to 605D and the multimedia client 210A continues to monitor the charging rate during the communication session on the first system. Otherwise, if AT 1's charging rate is determined to be greater than or equal to the charging rate threshold in 610D, AT 1 determines whether a second system is available for supporting AT 1's communication session with a level of application-layer performance expected to be higher than the first system, 615D. In the example of FIG. 6D, this means a system that is expected to provide a charging rate that is lower than the charging rate threshold, or at least lower than the charging rate associated with the first system for AT 1's communication session. For example, if the second system is a BCMCS system that is broadcasting a certain multicast session that the AT has been monitoring in the first system using a dedicated channel (e.g., in EV-DO or 1x), the charging rate of the second system will be cheaper. In an example, the charging rate threshold need not actually be used, and the process of FIG. 6D can rather advance directly to FIG. 6D where AT 1's current charging rate is simply compared against the charging rate(s) of one or more other available systems.

If no second system is determined to be available for supporting AT 1's communication session in 615D, the process returns to 605D and AT 1 continues to monitor the charging rate during the communication session on the first system. Otherwise, if the second system associated with a higher expected level of application-layer performance is determined to be available in 615D, the multimedia client 210A initiates or triggers the handoff of AT 1 from the first system to the second system, as is known in the art, 620D. After completing the handoff that is initiated in 620D, AT 1 continues the communication session on the second system, if possible, 625D. Accordingly, the embodiment of FIG. 6D illustrates one manner by which charging rates can be used to determine when to perform inter-system handoffs of the access terminal.

In the embodiments of FIGS. 6A through 6D, handoffs between a first system and a second system are described as being based on different application-layer performance parameters. While each of FIGS. 6A through 6D are described with respect to one particular application-layer performance parameter, it will be appreciated that multiple application-layer performance parameters can be considered with regard to any system handoff decision at AT 1. For example, two or more of OD, MER, location and/or a current charging rate may be considered in a decision with regard to whether to handoff to another system, with a network operator or user of AT 1 establishing which application-layer performance parameter has priority over other parameters. Thus, if any of the designated application-layer performance parameters degrades during AT 1's communication session, a handoff to another system may potentially be triggered so long as superior performance is expected at least with the regard to the degraded parameter (e.g., with at least a threshold amount of performance expected for each other parameter of equal or higher priority than the degraded parameter).

Further, FIGS. 6A through 6D are each described with respect to two particular systems; namely, AT 1's current system (“first system”) and a prospective system (“second system”) under consideration for a potential handoff. However, it is possible that multiple systems are available for handoff from the first system. In this case, each available system may be evaluated during a handoff decision, as described below with respect to FIG. 6E.

FIG. 6E illustrates the system-handoff process of FIG. 5 whereby one or more application-layer performance parameters are considered during a potential handoff of AT 1 from a first system (e.g., system 1) to one of a plurality of other potential systems (e.g., systems 2 . . . N, where N>2) during AT 1's communication session within the wireless communications system 10 in accordance with an embodiment of the disclosure.

Referring to FIG. 6E, AT 1 sets up a communication session on the first system, 600E, as described above with respect to 500 of FIG. 5. In 605E, the multimedia client 210A monitors one or more application-layer performance parameters for AT 1's communication session on the first system (e.g., OD, MER, charging rate, location, any combination thereof, etc.). After determining or measuring the one or more application-layer performance parameters for AT 1's communication session on the first system, the multimedia client 210A determines whether the determined parameters indicate that performance on the first system is sufficient for AT 1's communication session, 610E. If the first system is determined by the multimedia client 210A to provide adequate performance, the process returns to 605E and AT 1 continues to monitor the application layer performance parameters while the communication session continues on the first system. Otherwise, if the first system is determined by the multimedia client 210A not to provide adequate performance, the multimedia client 210A determines an expectation of performance for AT 1's communication session on each of a plurality of systems 2 . . . N, 615E. For example, if the application-layer performance parameters include a charging rate for the communication session, the multimedia client 210A can determine how much the subscriber using AT 1 would be charged on each of systems 2 . . . N. In another example, if the application-layer performance parameters include AT 1's location, the multimedia client 210A can determine which of systems 2 . . . n are available and/or a degree of performance based on AT 1's location, and so on.

In 620E, the multimedia client 210A determines a system among systems 2 . . . N associated with a highest performance expectation. In an example, it is possible that a given system among systems 2 . . . N has a higher performance expectation for one parameter and a lower performance expectation for another parameter. In this case, each performance parameter can be assigned a weight (e.g., as in an objective function) and a combined performance valuation can be computed, with the highest combined performance valuation corresponding to the system that is, overall, expected to provide a highest level of performance.

Next, in 625E, the multimedia client 210A determines whether the highest-rated system from 620E is expected to provide better performance than the first system that AT 1 is currently using for support of its communication session. If the highest-rated system among systems 2 . . . N is not expected to provide better performance than the first system, the process returns to 605E and AT 1 continues to monitor the application layer performance parameters while the communication session continues on the first system. Otherwise, if the highest-rated system among systems 2 . . . N is expected to provide better performance than the first system, the multimedia client 210A initiates or triggers the handoff of AT 1 from the first system to the highest-rated system among systems 2 . . . N, as is known in the art, 630E. After completing the handoff that is initiated in 630E, AT 1 continues the communication session on its new system, if possible, 635E.

As a specific example of the inter-system handoffs described above, an AT can handoff from a multicast system (the “first system”) to a wireless local area network (WLAN) (the “second system”). An issue with wireless multicast services, such as MBMS, is that the geographic coverage area, or “footprint,” can be limited. Further, wireless multicast services can have low in-building penetration. Accordingly, the various aspects of the disclosure expand the footprint of a wireless multicast service used for delivering group communications by using low cost WLANs, such as WiFi networks. In an aspect, the application server offloads the wireless multicast service onto one or more WLAN access points. This effectively expands the coverage of the wireless multicast service.

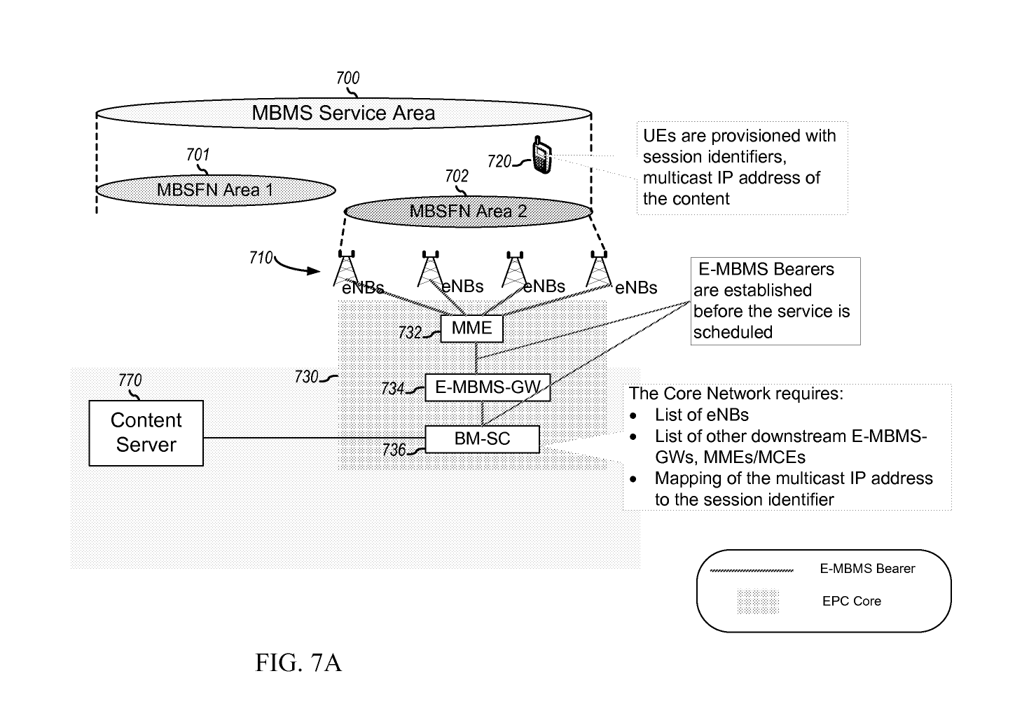

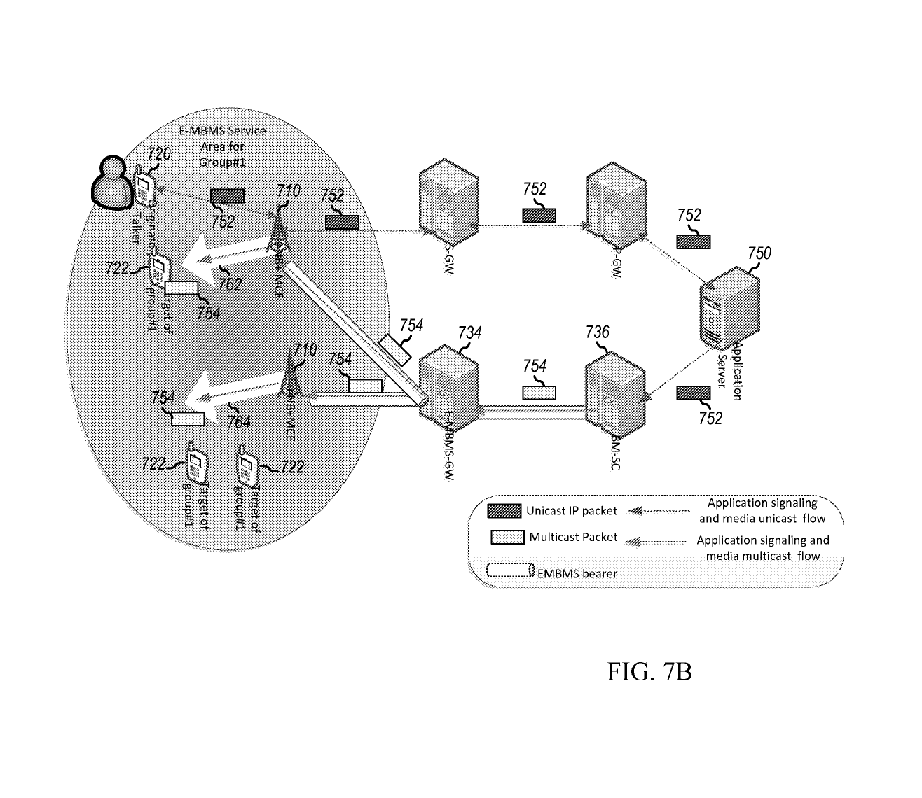

As noted in the foregoing, MBMS (referred to interchangeably as evolved MBMS (eMBMS)) can be used to distribute multicast data to groups and can be useful in group communication systems (e.g., PTT calls). FIG. 7A is an illustration of a wireless network that can implement MBMS, or eMBMS, which are used interchangeably herein. An MBMS service area 700 can include multiple MBSFN areas (e.g., MBSFN area 1 701 and MBSFN area 2 702). Each MBSFN area can be supported by one or more eNode Bs 710, which are coupled to a core network 730. Core network 730 can include various elements (e.g., MME 732, eMBMS gateway 734, and broadcast multicast service center (BM-SC) 736 to facilitate controlling and distributing the content from content server 770 (which may include an application server, etc.) to the MBMS service area 700. The core network 730 may require a list of eNode Bs within the network, list of other downstream E-MBMS-GWs 734, and (Mobility Management Entity) MMEs/MCEs 732, and a mapping of the multicast IP address to the session identifier. AT 720 within the network can be provisioned with session identifiers and multicast IP address of the content sent to it.

Typically an MME is a key control node for the LTE access network. It is responsible for idle mode AT tracking and paging procedure including retransmissions. It is involved in the bearer activation/deactivation process and is also responsible for choosing the SGW for a AT at the initial attach and at time of intra-LTE handover involving core network 730 node relocation and the MME is also responsible for authenticating the user. The MME 732 can also check the authorization of the AT to camp on the service provider's Public Land Mobile Network (PLMN) and enforces AT roaming restrictions. The MME 732 is the termination point in the network for ciphering/integrity protection for Non Access Stratum (NAS) signaling and handles the security key management. The MME 732 also provides the control plane function for mobility between LTE and 2G/3G access networks with S3 interface terminating at the MME.

FIG. 7B is another illustration of a wireless network that can implement MBMS as disclosed herein. In the illustrated network an application server 750 (e.g., a PTT server) can serve as the content server. The application server 750 can communicate media in unicast packets 752 to the network core where the content can be maintained in a unicast configuration and transmitted as unicast packets to a given AT (e.g., originator/talker 720) or can be converted through the BM-SC to multicast packets 754, which can then be transported target AT's 722. For example, a PTT call can be initiated by AT 720 by communicating with application server 750 via unicast packets 752 over a unicast channel. It will be noted that for the call originator/call talker, both the application signaling and media are communicated via the unicast channel on the uplink or the reverse link. The application server 750 can then generate a call announce/call setup request and communicate these to the target ATs 722. The communication can be communicated to the target ATs 722 via multicast packets 754 over a multicast flow, as illustrated in this particular example. Further, it will be appreciated in this example, that both the application signaling and media can be communicated over the multicast flow in the downlink or the forward link. Unlike conventional systems, having both the application signaling and the media in the multicast flow avoids the need of having a separate unicast channel for the application signaling. However, to allow for application signaling over the multicast flow of the illustrated system, an evolved packet system (EPS) bearer will be established (and persistently on) between the BM-SC 736, E-MBMS GW 734, eNBs 710 and target ATs 722.

In accordance with various aspects disclosed herein, some of the downlink channels related to eMBMS will be further discussed, which include.

MCCH: Multicast Control Channel;

MTCH: Multicast Traffic Channel;

MCH: Multicast Channel; and

PMCH: Physical Multicast Channel.

It will be appreciated that multiplexing of eMBMS and unicast flows are realized in the time domain only. The MCH is transmitted over MBSFN in specific sub-frames on physical layer. MCH is a downlink only channel. A single transport block is used per sub-frame. Different services (MTCHs) can be multiplexed in this transport block.

To achieve low latency and reduce control signaling, one eMBMS flow (762, 764) can be activated for each service area. Depending on the data rate, multiple multicast flows can be multiplexed on a single slot. PTT ATs (targets) can ignore and “sleep” between scheduled sub-frames and reduce power consumption when no unicast data is scheduled for the AT. The MBSFN sub-frame can be shared by groups in the same MBSFN service area. MAC layer signaling can be leveraged to “wake-up” the application layer (e.g., PTT application) for the target ATs.

Embodiments can use two broadcast streams, each a separate eMBMS flow over an LTE broadcast flow, with its own application level broadcast stream and its own (multicast IP address) for each defined broadcast region 702, 701 (e.g., a subset of sectors within the network). Although illustrated as separate regions, it will be appreciated that the broadcast areas 702, 701 may overlap.

In LTE, the control and data traffic for multicast is delivered over MCCH and MTCH, respectively. The Medium Access Control Protocol Data Units (MAC PDUs) for the ATs indicate the mapping of the MTCH and the location of a particular MTCH within a sub-frame. An MCH Scheduling Information (MSI) MAC control element is included in the first subframe allocated to the MCH within the MCH scheduling period to indicate the position of each MTCH and unused sub-frames on the MCH. For eMBMS user data, which is carried by the MTCH logical channel, MCH scheduling information (MSI) periodically provides at lower layers (e.g., MAC layer information) the information on decoding the MTCH. The MSI scheduling can be configured and scheduled before an MTCH sub-frame interval.

As discussed above, an issue with wireless multicast services, such as MBMS, is that the geographic coverage area, or “footprint,” can be limited. Further, wireless multicast services can have low in-building penetration. Accordingly, the various aspects of the disclosure expand the footprint of a wireless multicast service used for delivering group communications by using low cost WLANs, such as WiFi networks. In an aspect, the application server can offload the wireless multicast service onto one or more WLAN access points. This effectively expands the coverage of the wireless multicast service.

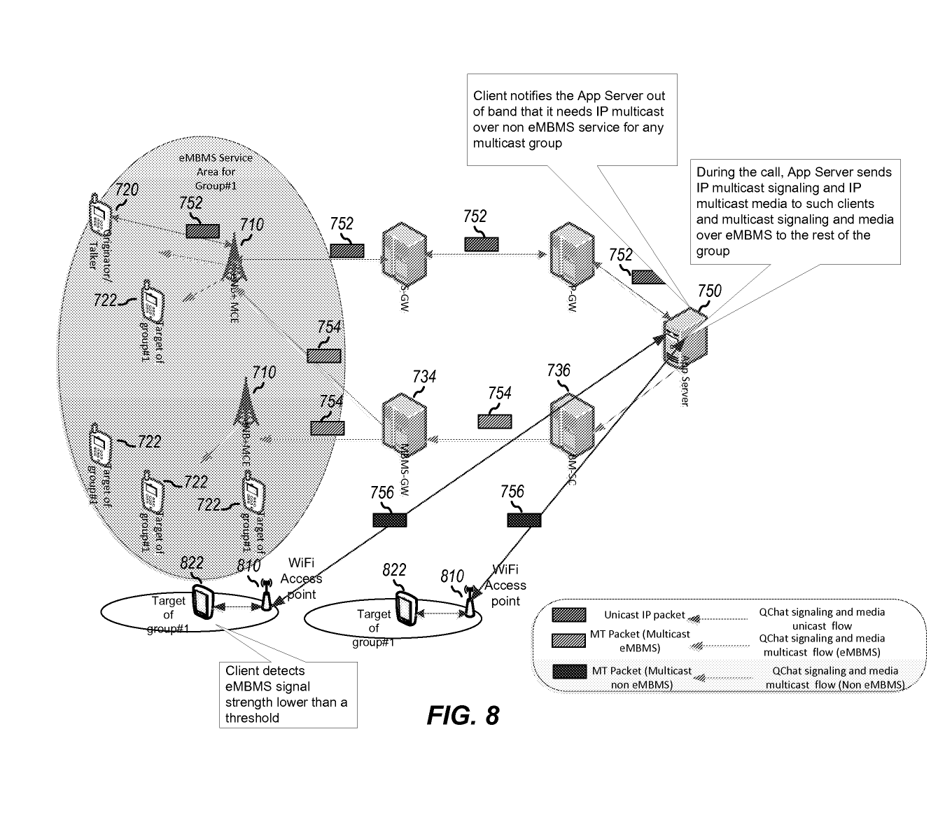

FIG. 8 illustrates an exemplary wireless network that can expand the footprint of a wireless multicast services used for delivering group communications by using low cost local wireless networks. As disclosed with reference to FIG. 7B, an application server 750 can serve as the content server. The application server 750 can communicate media in unicast packets 752 to the network core where the content can be maintained in a unicast configuration and transmitted as unicast packets to a given AT (e.g., originator/talker 720) or can be converted through the BM-SC 736 to multicast packets 754, which can then be transported to target AT's 722. For example, a PTT call can be initiated by AT 720 by communicating with application server 750 via unicast packets 752 over a unicast channel. It will be noted that for the call originator/call talker, both the application signaling and media are communicated via the unicast channel on the uplink or the reverse link. The application server 750 can then generate a call announce/call setup request and communicate these to the target ATs 722. The communication can be communicated to the target ATs 722 via multicast packets 754 over a multicast flow, as illustrated in this particular example. Further, it will be appreciated that both the application signaling and media can be communicated over the multicast flow in the downlink or the forward link. Unlike conventional systems, having both the application signaling and the media in the multicast flow avoids the need for having a separate unicast channel for the application signaling.

In the example of FIG. 8, one or more target ATs, such as target ATs 822, detect that the signal strength of the received MBMS signal is lower than a threshold. The threshold may be, for example, a handoff threshold, meaning that it is the threshold signal strength at which an AT would attempt to handoff to another MBMS. In response, ATs 822 notify the application server 750 via out-of-band signaling that they need IP multicast service over a non-MBMS, such as WiFi access points 810, for any multicast group calls. Accordingly, during the PTT group call, the application server 750 sends IP multicast signaling and media to ATs 822 over the non-MBMS and multicast signaling and media over the MBMS to the rest of the group, i.e., ATs 722. Specifically, the application server 750 sends multicast packets 756 to WiFi access points 810, which forward the multicast packets 756 to ATs 822.

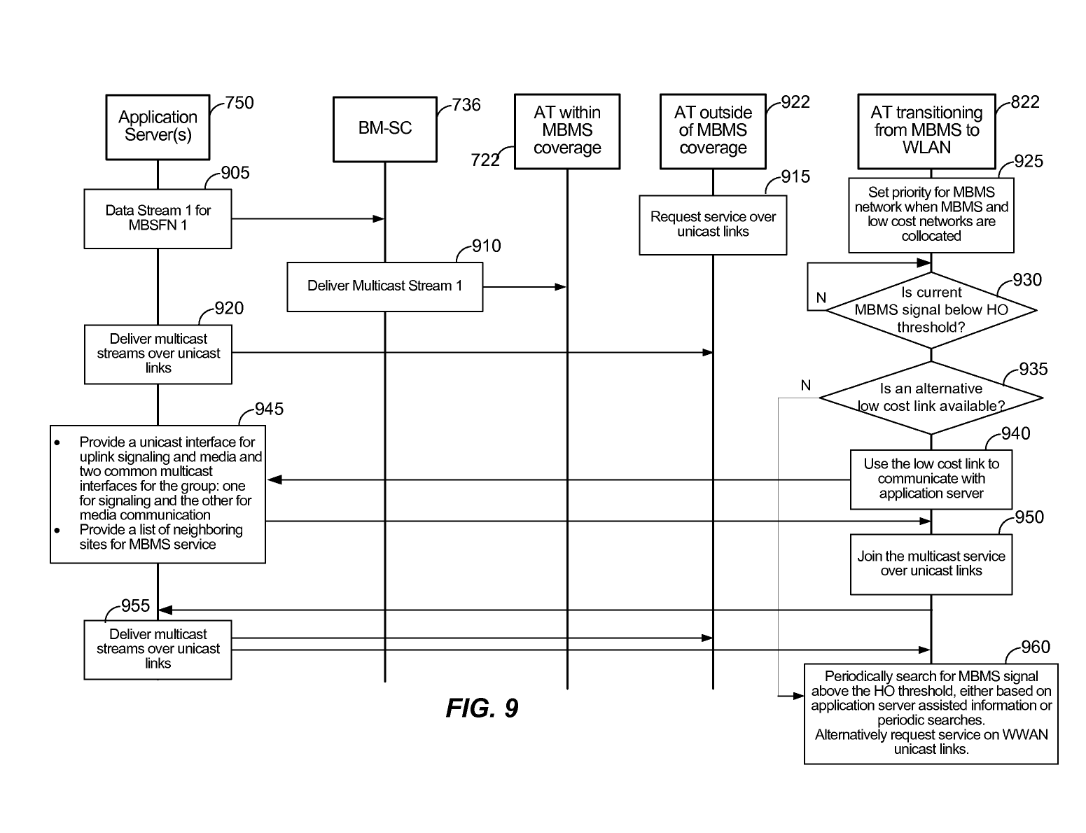

FIG. 9 illustrates an exemplary flow for expanding the footprint of a wireless multicast services used for delivering group communications by using low cost local wireless networks. The flow illustrated in FIG. 9 may be performed by the network illustrated in FIG. 8.

At 905, the application server 750 transmits a first data stream for a first MBSFN to the BM-SC 736. At 910, the BM-SC 736 delivers the first data stream as a first multicast stream to ATs 722 within the MBMS coverage area. At 915, an AT 922 outside of the MBMS coverage area requests a multicast service over unicast links. At 920, the application server 750 delivers the multicast stream(s) to the AT 922 over the established unicast links.

At 925, an AT 822 sets a priority, or preference, to use an MBMS network when an MBMS network and a low cost network, such as a WLAN, are collocated. At 930, the AT 822 determines whether or not a received MBMS signal is below a threshold, such as a handoff (HO) threshold. If it is not, then the AT 822 waits until it is. If, however, the received MBMS signal is below the threshold, then at 935, the AT 822 determines whether or not a low cost network, such as a WLAN, is available. If one is, then at 940, the AT 822 uses the WLAN to communicate with the application server 750.

At 945, the application server 750 provides a unicast interface for the AT 822 for uplink signaling and media and two common multicast interfaces for the group. One of the common multicast interfaces is for signaling and the other is for media communication. The application server 750 also provides the AT 822 with a list of neighboring sites for MBMS service.

At 950, the AT 822 joins the multicast service/group communication over the unicast link(s). At 955, the application server 750 delivers the multicast streams over the unicast link(s) to the AT 922 and the AT 822. At 960, the AT 822 periodically searches for an MBMS signal above the threshold, either based on information from the application server 750 or periodic searches. Likewise, if at 935, an alternative low cost link is not available, then the AT 822 proceeds to 960 and periodically searches for an MBMS signal above the threshold. Alternatively, the AT 822 can request service over wireless wide area network (WWAN) resources, such as, for example, an LTE unicast network.

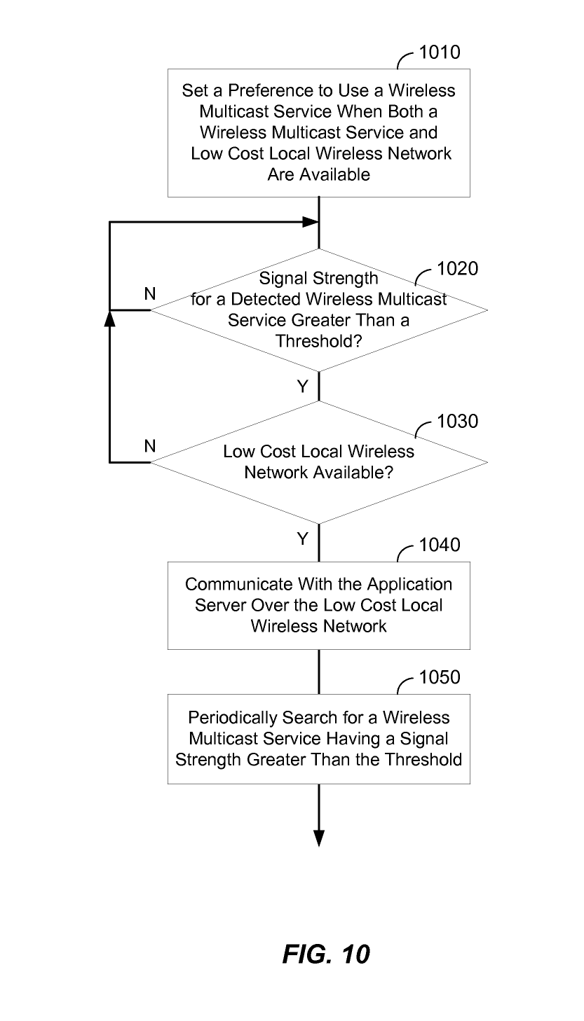

FIG. 10 illustrates an exemplary flow for using a low cost local wireless network to expand a coverage area of a wireless multicast service. The flow illustrated in FIG. 10 may be performed by an AT, such as AT 822 in FIG. 8.

At 1010, the AT sets a preference to use a wireless multicast service when both a wireless multicast service and a low cost local wireless network are available.

At 1020, the AT determines whether a signal strength for a detected wireless multicast service is greater than a threshold. The threshold may be a signal strength at which the wireless user device would attempt to handoff to another wireless multicast service. The detected wireless multicast service may be an MBMS.

At 1030, the AT determines whether a low cost local wireless network is available. The low cost local wireless network may be a WLAN.

At 1040, the AT communicates with an application server, such as application server 750 in FIG. 7B, over the low cost local wireless network based on the signal strength being not greater than the threshold and the low cost network being available. The communicating may include sending a request to the application server to send any multicast communications for the wireless user device over the low cost local wireless network instead of over the detected wireless multicast service. The communicating may also include receiving multicast communications that would otherwise be received over the detected wireless multicast service.

At 1050, the AT periodically searches for a wireless multicast service having a signal strength greater than the threshold. The periodically searching may be performed based on assistance information received from the application server. The assistance information may include a list of neighboring wireless multicast services.

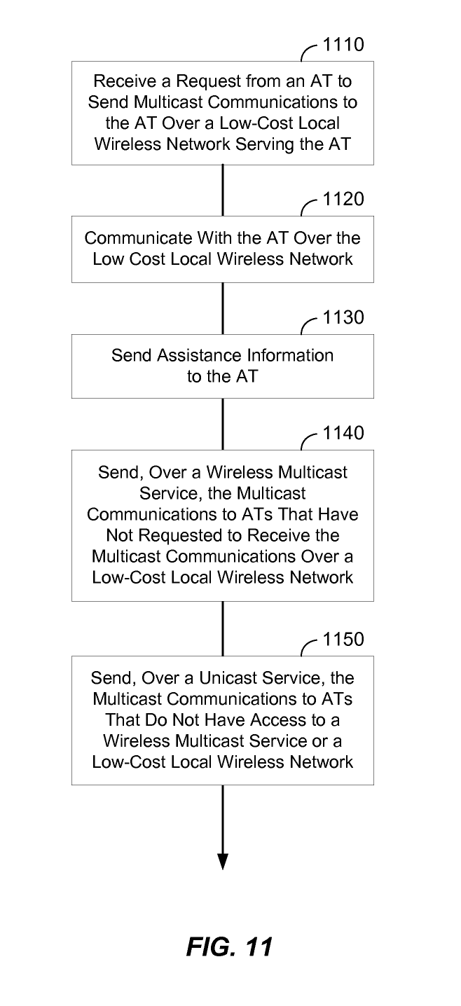

FIG. 11 illustrates an exemplary flow for using a low cost local wireless network to expand a coverage area of a wireless multicast service. The flow illustrated in FIG. 11 may be performed by an application server, such as application server 750 in FIG. 7.

At 1110, the application server receives a request from an AT, such as AT 822 in FIG. 8, to send multicast communications to the AT over a low cost local wireless network serving the AT. The AT sends the request based on a signal strength of a detected wireless multicast network being less than a threshold and the low cost network being available. The low cost local wireless network may be a WLAN. The wireless multicast service may be an MBMS.

At 1120, the application server communicates with the AT over the low cost local wireless network. The communicating may include sending multicast communications that would otherwise be sent over a wireless multicast service.

At 1130, the application server sends assistance information to the AT. The assistance information may include a list of wireless multicast services neighboring the AT.

At 1140, the application server sends, over a wireless multicast service, the multicast communications to ATs that have not requested to receive the multicast communications over a low cost local wireless network, such as AT 722 in FIG. 7.

At 1150, the application server sends, over a unicast service, the multicast communications to ATs that do not have access to a wireless multicast service or a low cost local wireless network, such as AT 922 in FIG. 9.

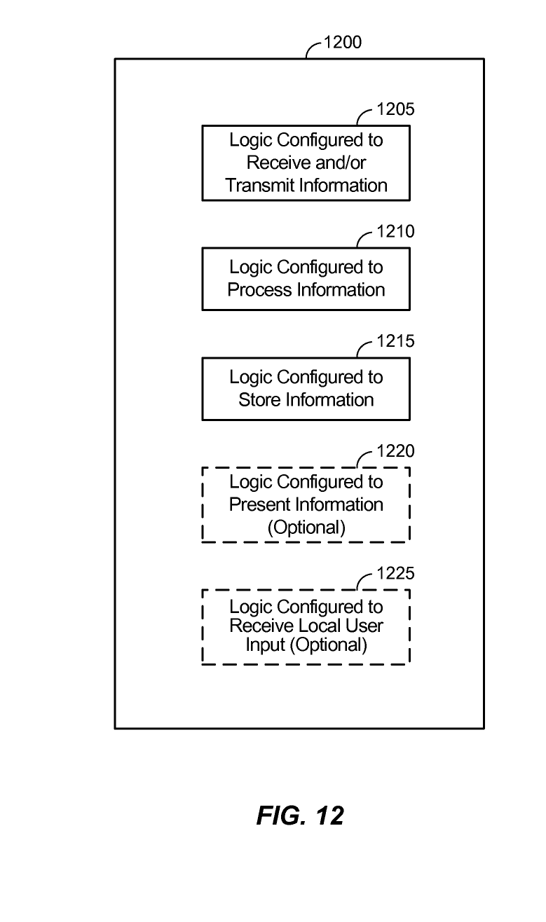

FIG. 12 illustrates a communication device 1200 that includes logic configured to perform functionality. The communication device 1200 can correspond to any of the above-noted communication devices, including but not limited to UEs 200, any component of the RAN 120, any component of the carrier network 126, any components coupled with the carrier network 126 and/or the Internet 175, and so on. Thus, communication device 1200 can correspond to any electronic device that is configured to communicate with (or facilitate communication with) one or more other entities over the wireless communications system 100 of FIG. 1.

Referring to FIG. 12, the communication device 1200 includes logic configured to receive and/or transmit information 1205. In an example, if the communication device 1200 corresponds to a wireless communications device (e.g., UE 200, RAN 120, etc.), the logic configured to receive and/or transmit information 1205 can include a wireless communications interface (e.g., Bluetooth, WiFi, 2G, CDMA, W-CDMA, 3G, 4G, LTE, etc.) such as a wireless transceiver and associated hardware (e.g., an RF antenna, a MODEM, a modulator and/or demodulator, etc.). In another example, the logic configured to receive and/or transmit information 1205 can correspond to a wired communications interface (e.g., a serial connection, a USB or Firewire connection, an Ethernet connection through which the Internet 175 can be accessed, etc.). Thus, if the communication device 1200 corresponds to some type of network-based server (e.g., PDSN, SGSN, GGSN, S-GW, P-GW, MME, HSS, PCRF, the application server 170, etc.), the logic configured to receive and/or transmit information 1205 can correspond to an Ethernet card, in an example, that connects the network-based server to other communication entities via an Ethernet protocol. As an example, the logic configured to receive and/or transmit information 1205 may include logic configured to communicate, by a wireless user device, with an application server over a low cost local wireless network based on a signal strength of a detected wireless multicast service being not greater than a threshold and the low cost network being available. As another example, the logic configured to receive and/or transmit information 1205 may include logic configured to receive, by an application server, a request from a wireless user device to send multicast communications to the wireless user device over a low cost local wireless network serving the wireless user device, wherein the wireless user device sends the request based on a signal strength of a detected wireless multicast network being less than a threshold and the low cost local wireless network being available, and logic configured to communicate, by the application server, with the wireless user device over the low cost local wireless network. In a further example, the logic configured to receive and/or transmit information 1205 can include sensory or measurement hardware by which the communication device 1200 can monitor its local environment (e.g., an accelerometer, a temperature sensor, a light sensor, an antenna for monitoring local RF signals, etc.). The logic configured to receive and/or transmit information 1205 can also include software that, when executed, permits the associated hardware of the logic configured to receive and/or transmit information 1205 to perform its reception and/or transmission function(s). However, the logic configured to receive and/or transmit information 1205 does not correspond to software alone, and the logic configured to receive and/or transmit information 1205 relies at least in part upon hardware to achieve its functionality.

Referring to FIG. 12, the communication device 1200 further includes logic configured to process information 1210. In an example, the logic configured to process information 1210 can include at least a processor. Example implementations of the type of processing that can be performed by the logic configured to process information 1210 includes but is not limited to performing determinations, establishing connections, making selections between different information options, performing evaluations related to data, interacting with sensors coupled to the communication device 1200 to perform measurement operations, converting information from one format to another (e.g., between different protocols such as .wmv to .avi, etc.), and so on. For example, the logic configured to process information 1210 may include logic configured to determine, by a wireless user device, whether a signal strength of a detected wireless multicast service is greater than a threshold, and logic configured to determine, by the wireless user device, whether a low cost local wireless network is available. The processor included in the logic configured to process information 1210 can correspond to a general purpose processor, a digital signal processor (DSP), an ASIC, a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. The logic configured to process information 1210 can also include software that, when executed, permits the associated hardware of the logic configured to process information 1210 to perform its processing function(s). However, the logic configured to process information 1210 does not correspond to software alone, and the logic configured to process information 1210 relies at least in part upon hardware to achieve its functionality.

Referring to FIG. 12, the communication device 1200 further includes logic configured to store information 1215. In an example, the logic configured to store information 1215 can include at least a non-transitory memory and associated hardware (e.g., a memory controller, etc.). For example, the non-transitory memory included in the logic configured to store information 1215 can correspond to RAM, flash memory, ROM, erasable programmable ROM (EPROM), EEPROM, registers, hard disk, a removable disk, a CD-ROM, or any other form of storage medium known in the art. The logic configured to store information 1215 can also include software that, when executed, permits the associated hardware of the logic configured to store information 1215 to perform its storage function(s). However, the logic configured to store information 1215 does not correspond to software alone, and the logic configured to store information 1215 relies at least in part upon hardware to achieve its functionality.

Referring to FIG. 12, the communication device 1200 further optionally includes logic configured to present information 1220. In an example, the logic configured to present information 1220 can include at least an output device and associated hardware. For example, the output device can include a video output device (e.g., a display screen, a port that can carry video information such as USB, HDMI, etc.), an audio output device (e.g., speakers, a port that can carry audio information such as a microphone jack, USB, HDMI, etc.), a vibration device and/or any other device by which information can be formatted for output or actually outputted by a user or operator of the communication device 1200. For example, if the communication device 1200 corresponds to UE 200 as shown in FIG. 3, the logic configured to present information 1220 can include the display 224 of UE 200. In a further example, the logic configured to present information 1220 can be omitted for certain communication devices, such as network communication devices that do not have a local user (e.g., network switches or routers, remote servers, etc.). The logic configured to present information 1220 can also include software that, when executed, permits the associated hardware of the logic configured to present information 1220 to perform its presentation function(s). However, the logic configured to present information 1220 does not correspond to software alone, and the logic configured to present information 1220 relies at least in part upon hardware to achieve its functionality.

Referring to FIG. 12, the communication device 1200 further optionally includes logic configured to receive local user input 1225. In an example, the logic configured to receive local user input 1225 can include at least a user input device and associated hardware. For example, the user input device can include buttons, a touchscreen display, a keyboard, a camera, an audio input device (e.g., a microphone or a port that can carry audio information such as a microphone jack, etc.), and/or any other device by which information can be received from a user or operator of the communication device 1200. For example, if the communication device 1200 corresponds to UE 200 as shown in FIG. 3, the logic configured to receive local user input 1225 can include the keypad 226, any of the buttons 228. In a further example, the logic configured to receive local user input 1225 can be omitted for certain communication devices, such as network communication devices that do not have a local user (e.g., network switches or routers, remote servers, etc.). The logic configured to receive local user input 1225 can also include software that, when executed, permits the associated hardware of the logic configured to receive local user input 1225 to perform its input reception function(s). However, the logic configured to receive local user input 1225 does not correspond to software alone, and the logic configured to receive local user input 1225 relies at least in part upon hardware to achieve its functionality.

Referring to FIG. 12, while the configured logics of 1205 through 1225 are shown as separate or distinct blocks in FIG. 12, it will be appreciated that the hardware and/or software by which the respective configured logic performs its functionality can overlap in part. For example, any software used to facilitate the functionality of the configured logics of 1205 through 1225 can be stored in the non-transitory memory associated with the logic configured to store information 1215, such that the configured logics of 1205 through 1225 each performs their functionality (i.e., in this case, software execution) based in part upon the operation of software stored by the logic configured to store information 1215. Likewise, hardware that is directly associated with one of the configured logics can be borrowed or used by other configured logics from time to time. For example, the processor of the logic configured to process information 1210 can format data into an appropriate format before being transmitted by the logic configured to receive and/or transmit information 1205, such that the logic configured to receive and/or transmit information 1205 performs its functionality (i.e., in this case, transmission of data) based in part upon the operation of hardware (i.e., the processor) associated with the logic configured to process information 1210.

Generally, unless stated otherwise explicitly, the phrase “logic configured to” as used throughout this disclosure is intended to invoke an embodiment that is at least partially implemented with hardware, and is not intended to map to software-only implementations that are independent of hardware. Also, it will be appreciated that the configured logic or “logic configured to” in the various blocks are not limited to specific logic gates or elements, but generally refer to the ability to perform the functionality described herein (either via hardware or a combination of hardware and software). Thus, the configured logics or “logic configured to” as illustrated in the various blocks are not necessarily implemented as logic gates or logic elements despite sharing the word “logic.” Other interactions or cooperation between the logic in the various blocks will become clear to one of ordinary skill in the art from a review of the embodiments described below in more detail.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., access terminal). In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

While the foregoing disclosure shows illustrative embodiments of the disclosure, it should be noted that various changes and modifications could be made herein without departing from the scope of the disclosure as defined by the appended claims. The functions, steps and/or actions of the method claims in accordance with the embodiments of the disclosure described herein need not be performed in any particular order. Furthermore, although elements of the disclosure may be described or claimed in the singular, the plural is contemplated unless limitation to the singular is explicitly stated.

What is claimed is:

1. A method for using a low cost local wireless network to expand a coverage area of a wireless multicast service, comprising:
determining, by a wireless user device, whether a signal strength of a detected wireless multicast service is greater than a threshold;
determining, by the wireless user device, whether a low cost local wireless network is available; and
communicating, by the wireless user device, with an application server over the low cost local wireless network based on the signal strength being not greater than the threshold and the low cost local wireless network being available.

2. The method of claim 1, wherein the communicating comprises receiving multicast communications that would otherwise be received over the detected wireless multicast service.

3. The method of claim 1, wherein the communicating comprises sending a request to the application server to send any multicast communications for the wireless user device over the low cost local wireless network instead of over the detected wireless multicast service.

4. The method of claim 1, wherein the threshold comprises a signal strength at which the wireless user device would attempt to handoff to another wireless multicast service.

5. The method of claim 1, wherein the low cost local wireless network comprises a wireless local area network (WLAN).

6. The method of claim 1, wherein the detected wireless multicast service comprises a multimedia broadcast/multicast service (MBMS).

7. The method of claim 1, further comprising:
setting a preference to use a wireless multicast service when both a wireless multicast service and a low cost local wireless network are available.

8. The method of claim 1, further comprising:
periodically searching for a wireless multicast service having a signal strength greater than the threshold.

9. The method of claim 8, wherein the periodically searching is performed based on assistance information received from the application server.

10. The method of claim 9, wherein the assistance information comprises a list of neighboring wireless multicast services.

11. A method for using a low cost local wireless network to expand a coverage area of a wireless multicast service, comprising:
receiving, by an application server, a request from a wireless user device to send multicast communications to the wireless user device over a low cost local wireless network serving the wireless user device, wherein the wireless user device sends the request based on a signal strength of a detected wireless multicast network being less than a threshold and the low cost local wireless network being available; and
communicating, by the application server, with the wireless user device over the low cost local wireless network.

12. The method of claim 11, wherein the communicating comprises sending multicast communications that would otherwise be sent over the wireless multicast service.

13. The method of claim 11, further comprising:
sending, over a wireless multicast service, the multicast communications to wireless user devices that have not requested to receive the multicast communications over a low cost local wireless network.

14. The method of claim 11, further comprising:
sending, over a unicast service, the multicast communications to wireless user devices that do not have access to a wireless multicast service or a low cost local wireless network.

15. The method of claim 11, wherein the low cost local wireless network comprises a wireless local area network (WLAN).

16. The method of claim 11, wherein the wireless multicast service comprises a multimedia broadcast/multicast service (MBMS).

17. The method of claim 11, further comprising:
sending assistance information to the wireless user device, the assistance information comprising a list of wireless multicast services neighboring the wireless user device.

18. An apparatus for using a low cost local wireless network to expand a coverage area of a wireless multicast service, comprising:
logic configured to determine, by a wireless user device, whether a signal strength of a detected wireless multicast service is greater than a threshold;
logic configured to determine, by the wireless user device, whether a low cost local wireless network is available; and
logic configured to communicate, by the wireless user device, with an application server over the low cost local wireless network based on the signal strength being not greater than the threshold and the low cost local wireless network being available.

19. The apparatus of claim 18, wherein the logic configured to communicate comprises logic configured to receive multicast communications that would otherwise be received over the detected wireless multicast service.

20. The apparatus of claim 18, wherein the logic configured to communicate comprises logic configured to send a request to the application server to send any multicast communications for the wireless user device over the low cost local wireless network instead of over the detected wireless multicast service.

21. The apparatus of claim 18, wherein the threshold comprises a signal strength at which the wireless user device would attempt to handoff to another wireless multicast service.

22. The apparatus of claim 18, further comprising:
logic configured to set a preference to use a wireless multicast service when both a wireless multicast service and a low cost local wireless network are available.

23. The apparatus of claim 18, further comprising:
logic configured to periodically search for a wireless multicast service having a signal strength greater than the threshold.

24. The apparatus of claim 23, wherein the logic configured to periodically search is performed based on assistance information received from the application server.

25. The apparatus of claim 24, wherein the assistance information comprises a list of neighboring wireless multicast services.

26. An apparatus for using a low cost local wireless network to expand a coverage area of a wireless multicast service, comprising:
logic configured to receive, by an application server, a request from a wireless user device to send multicast communications to the wireless user device over a low cost local wireless network serving the wireless user device, wherein the wireless user device sends the request based on a signal strength of a detected wireless multicast network being less than a threshold and the low cost local wireless network being available; and
logic configured to communicate, by the application server, with the wireless user device over the low cost local wireless network.

27. The apparatus of claim 26, wherein the logic configured to communicate comprises logic configured to send multicast communications that would otherwise be sent over the wireless multicast service.

28. The apparatus of claim 26, further comprising:
logic configured to send, over a wireless multicast service, the multicast communications to wireless user devices that have not requested to receive the multicast communications over a low cost local wireless network.

29. The apparatus of claim 26, further comprising:
logic configured to send, over a unicast service, the multicast communications to wireless user devices that do not have access to a wireless multicast service or a low cost local wireless network.

30. The apparatus of claim 26, further comprising:
logic configured to send assistance information to the wireless user device, the assistance information comprising a list of wireless multicast services neighboring the wireless user device.
